(19) United States
(12) Patent Application Publication
(10) Pub. No.: US 2016/0030868 A1
(43) Pub. Date: Feb. 4, 2016

(54) PERIPHERALLY ENRICHED FIBROUS MEDIA AND METHOD OF MAKING

(71) Applicant: DONALDSON COMPANY, INC., Minneapolis, MN (US)

(72) Inventors: Hemant Gupta, Apple Valley, MN (US); Ajay Singh, Apple Valley, MN (US)

(21) Appl. No.: 14/777,341

(22) PCT Filed: Mar. 14, 2014
(86) PCT No.: PCT/US14/29204

§ 371 Date: Sep. 15, 2015

Related U.S. Application Data
(60) Provisional application No. 61/794,213, filed on Mar. 15, 2013.

(51) Int. Cl. B01D 39/14; B29C 70/02; B01D 39/16

(52) U.S. Cl. CPC B01D 39/14; B01D 39/163; B29C 70/021; B01D 2239/0407; B01D 2239/086; B01D 2239/0428; B29L 2007/002

(57) ABSTRACT

Described herein are peripherally enriched fibrous media. The peripherally enriched fibrous media are nonwoven media including at least one peripheral region that is enriched in one or more binder resins, and at least one bulk region that is significantly or substantially free of binder resin, the regions being present in a single fibrous media layer. Methods of making the media and performance advantages of the media in one or more filtration applications are also described.

This application is being filed as a PCT International Patent application on Mar. 14, 2014 in the name of Donaldson Company, Inc., a U.S. national corporation, applicant for the designation of all countries and Hemant Gupta, an Indian Citizen; and Ajay Singh, a U.S. Citizen, inventors for all designated states, and claims priority to U.S. Provisional Patent Application No. 61/794,213, filed Mar. 15, 2013, the contents of which are herein incorporated by reference in its entirety.

### BACKGROUND

Fibrous media in filtration industry are used to remove contaminants from fluids. For example, solid particulates, gel-like particulates, or aerosol/mist contaminants are removed from fluids while offering minimum amount of resistance to fluid flow through the fibrous media. Commonly filtered fluids include liquids such as oils, lubricants, fuels, or water; and gases such as air. The structure of the fibrous media is critical for effective filtration and is varied depending on many factors including fluid properties, nature of contaminants, operating conditions, and need for surface vs. depth loading of contaminant. All these factors and more are taken into consideration during media design. For example, low permeability media are generally designed for fuel filtration, moderate permeability for oil filtration, and high permeability for air filtration applications.

There are many limitations with the current filter media, prominent among them being limited contaminant holding capacity, high pressure drop and/or pressure drop that increase quickly over filter lifetime, low efficiency, and the like. Many factors contribute to contaminant holding capacity and pressure drop increase across the media as the result of contaminant loading during filtration. Therefore, it is greatly desired to engineer filter media that can provide enhanced performance under different conditions.

Many filtration media are designed to hold contaminants in the form of cake at the surface (Surface Loading Media) or are multilayered media wherein the various layers carry out different functions. For example, in some multilayered media, one or more layers acts as depth loading layers for contaminant storage, while the rest of the layers acts as an efficiency layers. An efficiency layer is a finely pored filter layer that prevents contaminant migration through the media. In many cases, the media is shaped; that is, pleated, corrugated or dimpled. Shaping provides additional surface area for loading of solid particulates. In such shaped media, the fluid also flows in the channels within the pleats, which in some cases increases the overall pressure drop across the media. In some cases, layers of filter media are also adhesively bonded to prevent gapping, sagging, or other physical means of failure of the multilayered construction. Higher capacity translates into longer filter life, but necessitates a more “open” media structure which in turn can lead to loss of efficiency.

There is a need in the industry to provide fibrous filter media with improved capacity and decreased pressure drop without compromising efficiency.

Binder resins are employed in fibrous media to bind fibers to one another and thereby provide a more robust media and prevent sloughing of fibers from the media during use. Binder resins are conventionally employed in a wide variety of fibrous filtration media. Much effort has been devoted to forming filtration media having binder resin evenly dispersed throughout the media. Conventional wisdom holds that without binder being evenly distributed throughout the filter media, the structural integrity of the media would be greatly reduced. While binder resins are known to increase structural integrity, their presence is associated with lowered efficiency and decrease in overall loading capacity as well as higher pressure drop.

There is a need in the industry to provide fibrous filter media having robust structural integrity while maintaining high efficiency, high overall load capacity, and lower pressure drop.

### BRIEF DESCRIPTION OF THE DRAWINGS

FIG. 1A-1F is a series of scanning electron micrographs of a fibrous media.

FIG. 2A-2E is a series of scanning electron micrographs of an embodiment of a peripherally enriched fibrous media as described herein.

FIG. 2F is a composite scanning electron micrograph of the peripherally enriched fibrous media of FIGS. 2A-2E.

FIG. 3 is a plot of Figure of Merit as a function of percent binder resin pickup for fibrous media with and without a hydrophobic agent.

FIG. 4 is a plot of Figure of Merit as a function of percent binder resin pickup for another fibrous media with and without a hydrophobic agent.

### SUMMARY

We report herein peripherally enriched fibrous media and methods of making and using the peripherally enriched fibrous media. The peripherally enriched fibrous media includes a peripheral region, or periphery, that is enriched in one or more binder resins, wherein the periphery is an area near a surface of a single layer of a fibrous media and includes the surface thereof. The peripherally enriched media has at least two distinct and identifiable regions in a single fibrous media layer, the regions including at least a peripheral region, or periphery, and at least one bulk region. The periphery is characterized by a higher concentration of one or more binder resins or binder polymers when compared to the bulk, or an enhanced structure provided by the binder resin at the periphery, or both. In some embodiments the bulk is surrounded by the periphery, wherein the periphery includes all surfaces thereof. The periphery is enriched in binder resin, wherein the binder resin in some embodiments further includes one or more additional binder materials, and the bulk is significantly or substantially free of binder.

The methods employed to make the peripherally enriched fibrous media are suitably applied to any non-woven fibrous media manufacturing process. Further, methods to form peripherally enriched fibrous media are suitably employed in conjunction with polymer processing systems used to form the fibers that in turn are used to form the non-woven fibrous media. The methods are easily adapted to any conventional methodology used to make nonwoven media, including wet laid, air laid, meltblown, electrospun, and other such methods.

The peripherally enriched fibrous media are suitably employed in any conventional application where nonwoven fibrous media are used to filter impurities from fluids, wherein several distinct and significant performance benefits are realized by providing the peripherally enriched binder resin along with optional additional binder materials to the fibrous media.

### DETAILED DESCRIPTION

### 1. Definitions

As used herein, the term “fiber” means any one or more, depending on context, of a large number of compositionally related fibers such that all the fibers fall within a range of fiber sizes or fiber characteristics that are distributed (typically in a substantially normal or Gaussian distribution) about a mean or median fiber size or characteristic. It is to be understood that the term “fiber” generally relates to a source of fiber. Sources of a fiber are typically fiber products, wherein large numbers of the fibers have similar composition diameter and length or aspect ratio. Fibers are articles having a width:length or diameter:length aspect ratio of about 1:10 to 1:1×10⁷, for example about 1:100 to 1×10⁶, wherein the fiber length is typically about 50 cm or less. In some embodiments fibers are substantially cylindrical, wherein the diameter of the cylinder is about 2 nm to 1 mm. In some embodiments, fibers are crimped. Fibers include monocomponent, bicomponent, and multicomponent fibers such as core/sheath, lobed, or islands-in-the-sea configurations. Fiber compositions are inorganic or organic. Fibers, including mixtures of two or more fibers, are employed to form fibrous media.

As used herein, the term “media” or “fibrous media” means a sheet-like or planar nonwoven fibrous structure having a thickness of about 0.05 mm to an indeterminate or arbitrarily larger thickness. In some embodiments, the thickness dimension is 0.5 mm to 2 cm, 0.8 mm to 1 cm or 1 mm to 5 mm. The media width is not particularly limited, but in some embodiments ranges from about 2.00 cm to an indeterminate or arbitrary crossweb width. The length of the media is an indeterminate or arbitrary length. In various embodiments the media is flexible, machinable, pleatable and otherwise capable of being formed into a filter element or filter structure that is stacked, wrapped, or employed otherwise in a filter element without limitation. The media can include one or more gradient regions, one or more regions of significantly constant composition, or both. The fibrous media includes non-fibrous materials in various embodiments, such as non-fibrous polymers, surfactants, fiber coatings, particulates, and the like.

As used herein, the term “layer”, further as applied to fibrous media, means a single, discrete sheet-like or planar nonwoven fibrous structure formed by a manufacturing process. Thus, a layer is distinguishable from a stacked series of media thicknesses, or wound media employed in a filter element, even where adhesives or other physical or chemical means are employed to bond layers together.

As used herein, the term “region” means a portion of a fibrous media, wherein the region has a thickness less than the overall fibrous media thickness, or a crossweb width less than the overall fibrous media crossweb width, or a diameter less than the overall media diameter for a disk-shaped fibrous media. A region encompasses about 1% to about 99% of the thickness or crossweb width of the media, or about 5% to 95% of the thickness or crossweb width of the media, or about 10% to 90% of the thickness or crossweb width of the media, or in various intermediate levels such as 2%, 5%, 12%, 22%, 38%, 55%, 71%, 97%, and all other such values individually represented by 1% increments between 1% and 99%, and in any range spanning between any individual values between 1% and 99% in 1% increments, for example ranges such as about 3% to 17%, about 36% to 38%, about 8% to 79%, and the like, as provided herein to describe thickness or width of a region.

As used herein, the term “periphery” or “peripheral region” means one or more regions, according to context, of a single layer of a fibrous media that includes an external surface thereof. Where the media is a substantially planar, sheetlike fibrous mat, a peripheral region includes a major surface, both major surfaces, an edge surface, two or more edge surfaces, or any combination of surfaces thereof.

As used herein, the term “bulk”, or “bulk region” means one or more selected regions, according to context, of a single layer of fibrous media. In some embodiments, two or more bulk regions collectively form the bulk of the fibrous media. The bulk excludes at least one periphery of the fibrous media. The bulk and the periphery together make up the entirety of one layer of a peripherally enriched fibrous media.

As used herein, the term “binder” or “binder resin” means a composition including one or more non-fibrous polymeric compounds that is added to a fibrous media after the media is formed. The binders are added to the nonwoven media in a liquid, such as in a waterbased dispersion or emulsion, or in a solvent based solution or dispersion. In various embodiments, delivery to the media is accomplished via dipping, spraying, or any other conventional means of coating the fibrous media. In some embodiments, the binder resin is capable of physically binding or adhering fibers together in the fibrous media.

As used herein, the term “additional binder materials” means a compound, functionality, particle, or the like that is added to the binder resin solution, dispersion, or emulsion and is delivered to the media in conjunction with, and as part of, the binder resin solution, dispersion, or emulsion.

As used herein, the term “hydrophobic agent” means a compound or composition that is capable of coating, depositing on, reacting with, or adhering to a fiber and lowering the surface energy thereof. The hydrophobic agent is a small molecule, an oligomeric molecule, a polymer, a particle, or a colloidal composition. In some embodiments the hydrophobic agent is a fugitive hydrophobic agent wherein a fugitive hydrophobic agent is a hydrophobic agent that evaporates, degrades, or otherwise leaves the fiber once a peripherally enriched fibrous media is formed, for example during a drying process. In other embodiments the hydrophobic agent is a permanent hydrophobic agent, wherein a permanent hydrophobic agent is one that does not evaporate, degrade, or otherwise leave the fiber once a peripherally enriched fibrous media is formed. In some embodiments, a permanent agent is also a crosslinking agent, or an agent that chemically bonds to the surface of a fiber.

As used herein, the term “hydrophobic media” means a fibrous media having one or more hydrophobic agents present therein, wherein the media does not include a binder resin.

As used herein, the term “gradient” means some property of a fibrous media that varies typically in the crossweb or thickness direction in at least a region of the fibrous media. The variation can occur from a first surface to a second surface or from a first edge to a second edge of the fibrous media, or within a region thereof. The gradient can be a physical property gradient or a chemical property gradient. The gradient can be a gradient in at least one of the group consisting of mechanical strength, permeability, pore size, fiber diameter, fiber length, efficiency, solidity, wettability, chemical resistance and temperature resistance. Within such a gradient, the fiber size can vary, the fiber concentration can vary, or any other compositional aspect can vary. Such variations in composition or property can occur in a linear gradient distribution or non-linear gradient distribution.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

As used herein, the term “optional” or “optionally” means that the subsequently described event or circumstance may but need not occur, and that the description includes instances where the event or circumstance occurs and instances in which it does not.

As used herein, the term “significant” or “significantly” means at least half, or a majority. For example, a solution that contains a “significant amount” of a component contains 50% or more of that component by weight, or by volume, or by some other measure as appropriate and in context. A solution wherein a significant portion of a component has been removed has had at least 50% of the original amount of that component removed by weight, or by volume, or by some other measure as appropriate and in context.

As used herein, the term “substantial” or “substantially” means nearly completely, and includes completely. For example, a solution that is “substantially free” of a specified compound or material may be free of that compound or material, or may have a trace amount of that compound or material present, such as through unintended contamination or incomplete purification. A composition that has “substantially only” a provided list of components may consist of only those components, or have a trace amount of some other component present, or have one or more additional components that do not materially affect the properties of the composition. A “substantially planar” surface may have minor defects, or embossed features that do not materially affect the overall planarity of the film. In terms of a composition, “substantially” means greater than about 90%, for example about 95% to 100%, or about 97% to 99.9%, for example by weight, or by volume, or by some other measure as appropriate and in context.

### 2. Peripherally Enriched Fibrous (PEF) Media

The peripherally enriched fibrous (PEF) media of the invention have at least two distinct and identifiable regions within a single media layer. The at least two regions include at least one peripheral region and at least one bulk region. The peripheral and bulk regions are differentiated by the presence of a binder resin, and optionally one or more additional binder materials, significantly or substantially enriched within the one or more peripheral regions. In some embodiments, the binder resin and optionally one or more additional binder materials are significantly, or substantially, absent from the bulk. In some embodiments, the one or more peripheral regions are associated with an enhanced binder film structure. In some embodiments, the peripheral and bulk regions include the same fibers and distribution of fibrous materials; in other embodiments, the fibers or fiber distribution is different between the one or more peripheral regions and the bulk. While differences in fiber content exist in some embodiments between the peripheral and bulk regions of the PEF media, such differences are not the defining characteristic of the PEF media. Rather, the defining characteristic of the PEF media is the presence of one or more binder resins, optionally including other additional binder materials, that are enriched in the one or more peripheral regions as compared to the one or more bulk regions. In some embodiments, a characteristic of the PEF media is an enhanced binder film structure at the periphery.

The PEF media are nonwoven fibrous media. The fibers included in the PEF media are not limited by composition. The PEF media include, in various embodiments, organic fibers, inorganic fibers, and mixtures of two or more types of fibers. Organic fibers include those formed from synthetic polymers such as polyolefins, polyesters, polyamides, halogenated polymers, and polyurethanes; bicomponent or multicomponent fibers formed from one or more of these polymer genuses; biopolymers such as celluloses, modified celluloses, hemp, or abacus; and combinations of two more such fibers. Inorganic fibers are formed from glass, metals and other non-organic carbon source materials. In many embodiments, a blend of organic and inorganic fibers are selected to impart a combination of mechanical strength and flexibility to the fibrous media overall. In some embodiments, a mixture of one or more glass fibers and one or more synthetic fibers such as polyester, polyolefin, polyamide, or cellulosic fiber, or bicomponent fiber, are blended to form a nonwoven media. In some embodiments, the two or more fibers are a mixture of fibers having different fiber sizes. For example, a mixture of fibers of the same or different composition having different average diameters, lengths, or aspect ratios are used in some embodiments to form the nonwoven media.

The bulk includes one or more bulk regions; thus, in some embodiments, the bulk is a single region that is significantly consistent in terms of the materials that are incorporated therein, and in some embodiments is consistent with respect to the contents and/or distribution of contents therein. In other embodiments, the bulk is a series of regions having different materials in each region. In some embodiments, the PEF media are gradient media. Gradient media are made, in some embodiments, by wet laid methods by employing the methods and materials described in U.S. Patent Publication No. 2010/0187171. In such embodiments, the bulk includes more than one bulk region, wherein the fibers that form the one or more bulk regions are different from each other, and in some embodiments are different between a bulk region and a peripheral region. In some embodiments, the PEF media are made using fiber mixtures and constructions such as those described in U.S. Pat. No. 7,314,497.

The PEF media include, in some embodiments, one or more additional materials dispersed substantially throughout the media, or throughout one or more bulk regions of the media. The one or more additional dispersed materials include, but are not limited to, particulates, colorants, thermal stabilizers, antimicrobial compounds, surfactants, crosslinkers, and the like. The PEF media are not particularly limited as to additional dispersed materials provided that the PEF media does not include a binder resin dispersed evenly throughout the media. In some embodiments, such as where the media is a gradient media, the one or more additional dispersed materials are dispersed in a gradient fashion, that is, with different amounts of such materials in one or more bulk regions, or both bulk and peripheral regions.

One material that is included in many embodiments of the PEF media of the invention is a hydrophobic agent. A hydrophobic agent is required, in some embodiments, to lower the surface energy of one or more of the fibers present in the media sufficiently to cause, or increase, the tendency of one or more resin binders to migrate toward one or more peripheral regions of the media after delivery of the resin binder to the media and during drying of the resin. In other embodiments, the hydrophobic agent is added to prevent the binder resin from wetting out onto the fibers altogether during operations such as dipping and soaking the fibrous media in the binder dispersion, emulsion, or solution. The hydrophobic agent is added to the media in any of a number of ways depending on the media formation method and fibers included in the media. For example, in some embodiments the hydrophobic agent is added directly to individual fibers during fiber formation. Thus, for example in a melt blown or electrospinning process, fibers have a hydrophobic agent deposited on the polymeric fibers during the fiber formation, for example where lubricants are employed and in some embodiments as a mixture with one or more lubricants; then the hydrophobic fibers are employed to make a nonwoven media layer. In other embodiments, the hydrophobic agent is added during media layer formation along with fibers that were previously formed. Thus, for example in a wet laid process, the hydrophobic agent is added to a fiber slurry, where it deposits on fiber surfaces as the liquid from the slurry is drained from the formed media. In still other embodiments, a formed media is treated with a hydrophobic agent by dipping, spraying, brushing, nip roll coating, and the like after the media layer is formed. Thus, the means of adding the hydrophobic agent to the media is not particularly limited.

The hydrophobic agent, in many embodiments, does not interfere with or change the bulk media properties of permeability, pore size, and efficiency. The principal bulk media property affected when the hydrophobic agent is added to the media is the hydrophobicity of the media, as determined, for example, by subjecting the media to a steadily increasing pressure of water until penetration occurs on the surface of the media.

It will be appreciated that the structure and amount of the hydrophobic agent deposited on the fibrous media determines the degree of wetting of the binder solution, emulsion, or dispersion onto the fibers and also affects the migration of the binder toward the periphery during drying. In various embodiments, careful selection of the hydrophobic agent and selection of the weight percent hydrophobic agent imparted to the fibrous media enables control of the binder placement in a subsequent step, as will be explained in further detail below.

In certain embodiments, the hydrophobic agent is a surfactant, a defoamer, or a wetting agent. In certain embodiments, the hydrophobic agent is a hydrophobic silica, a silicone oligomer, a fluorochemical surfactant, or a wax. Hydrophobic silica is a silica particulate that has hydrophobic groups chemically bonded to the surface. Hydrophobic silica is made from fumed or precipitated silica, typically by capping surface silanol functionality with trimethylsilyl moieties. In some embodiments, the hydrophobic agent is a silicone, that is, a polydialkylsiloxane oligomer or short-chain polymer wherein the alkyl moieties have between 1 and 18 carbons. In certain embodiments, the polydialkylsiloxane oligomer or short chain polymer is a polydimethylsiloxane oligomer or short-chain polymer (also referred to as a silicone oil), or a cyclic siloxane such as hexamethylcyclotrisiloxane or octamethylcyclotetrasiloxane; in some such embodiments, the cyclic siloxanes are capable of ring-opening reactions when present on the fiber surface and self-react and/or react with one or more fiber surfaces. One example of a useful hydrophobic agent is Nalco 7468, sold by Nalco Holding Co. of Naperville, Ill. In certain embodiments, the hydrophobic agent is a silane coupling agent having siloxane, alkyl, or fluoroalkyl chain attached thereto, wherein the silane coupling agent reacts to itself and in some embodiments to a fiber surface. For example, trimethylsilanol, alkyl trialkoxysilanes wherein the alkyl group has between 1 and 18 carbons, fluoroalkyl trialkoxysilanes wherein the fluoroalkyl group has between 1 and 8 carbons, hexamethyldisilazane and other silane and silazane compounds, and polydimethylsiloxane compounds endcapped with alkoxysilane functionalities are usefully employed in some embodiments; in particular, where glass fibers are employed, such compounds are capable of reacting with silanol groups present on the glass fiber surface and bonding thereto. Such compounds are also capable in some embodiments of reacting to form an oligomeric or polymeric structure on the surface of the fibers. In some embodiments the hydrophobic agent is an alkyl dimethicone, that is, a silicone oligomer having both dimethylsiloxane repeat units and methylalkylsiloxane repeat units, wherein the alkyl moieties have between 2 and 50 carbon atoms. In some embodiments, the hydrophobic agent is a wax, such as ethylene bis stearamide, paraffin wax, an ester wax, or a fatty alcohol wax. In some embodiments wax compositions also include one or more surfactants. In some embodiments the hydrophobic agent is a vegetable oil or a mineral oil. In such embodiments, the oil is delivered neat, as an emulsion, or in a solvent, wherein water or solvent is subsequently dried from the fibers. In some such embodiments, the oil is a drying oil or an oil that cures in place, such as walnut oil or linseed oil.

In some embodiments, the hydrophobic agent is a hydrocarbon, fluorocarbon, or silicone based surfactant. Hydrocarbon surfactants are nonionic, cationic, anionic, or zwitterionic compounds having between 4 and 30 carbons and can include, for example, carboxamide groups, sulfonamide groups, carboxyester groups, hydroxy groups, alkoxy groups, and the like. Nonionic surfactants include those having ethylene oxide and propylene oxide functionality. Cationic surfactants include those having tetraalkylammonium functionality. Anionic surfactants include those having sulfonate or carboxyl functionality. Zwitterionic surfactants include those having both amino and carboxyl functionality or both amino and sulfonate functionality. Fluorocarbon surfactants have structures similar to the hydrocarbon surfactants but include in place of or in addition the hydrocarbon functionality one or more fluorocarbon groups, wherein the fluorocarbon groups include partially fluorinated or perfluorinated carbons. The fluorocarbon surfactants have at least 1 carbon that is fluorinated and up to 8 perfluorinated carbons. In some embodiments, fluorinated surfactants have between 1 and 8 total carbon atoms. Silicone surfactants include nonionic wetting agents such as SILWET® trisiloxane ethoxylate surfactants, available from MOMENTIVE® Performance Materials Inc. of Columbus, Ohio; and surfactants and emulsions including them as described in O'Lenick, Jr., “Silicone Emulsions and Surfactants—A Review”, Part 2, available at http://www.siliconespectator.com/articles/Silicone_Spectator_March_{—}2009.pdf. In general, the hydrophobic agent is restricted only as to the ability of the selected hydrophobic agent to coat and reside on fibers, and in so doing decrease the fiber surface energy.

The hydrophobic agent is typically deposited on fibers that are present throughout both the peripheral and bulk regions of the PEF media. In certain embodiments, the hydrophobic agent is present on the surface of substantially every fiber in the media. In some embodiments, where blends of fibers are employed, the hydrophobic agent may associate with and preferentially coat one type of fiber compared to another fiber, depending on the surface chemistry of the fiber. In some embodiments where the hydrophobic agent is added directly to a fiber during fiber formation, such coated fibers are blended with other fibers that are not coated. It will be understood that in some embodiments the hydrophobic agent is not necessarily applied to one or more particular types of fibers, so long as the surface energy of the particular fiber is sufficiently low to cause resin binders subsequently added to the media to migrate toward one or more peripheral regions of the media after delivery of the resin binder to the media and during drying of the resin.

The one or more peripheral regions of the PEF media include one or both major surfaces of a sheet-like planar media, one or more edge portions of a sheet-like planar media, or combinations thereof. In some embodiments the bulk is surrounded by the periphery, wherein the periphery includes all surfaces thereof. The peripheral regions are characterized by a significantly, or substantially, higher concentration of one or more binder resins compared to the amount of binder resin in the bulk. In some embodiments, the bulk regions are substantially free of binder resin. In some embodiments, the PEF media includes both major surfaces thereof, wherein each peripheral region encompasses about 5% to 25% of the total thickness of the media and the peripheral regions together include about 80% to 100% by weight of the total amount of binder present in the media. Thus, for example, where a PEF media includes two peripheral regions encompassing the two major surfaces thereof, each peripheral region includes about 40% to 50% by weight of the total amount of binder present in the media, or about 41% to 49% by weight of the total amount of binder present in the media, or about 42% to 48% by weight of the total amount of binder present in the media, or in various intermediate levels such as 41.5%, 45.7%, 47.5%, 49.9%, and all other such values individually represented by 0.1% increments between 40% and 50%, and in any range spanning between any individual values in 0.1% increments, for example ranges such as about 40.5% to 40.7%, about 41.0% to 42.2%, about 48.9% to 50%, and the like. Similar ranges, in 0.1% increments, apply to media having one peripheral region and therefore 80% to 100% by weight of the total amount of binder present in the media.

In some embodiments, the one or more peripheral regions of the PEF media are characterized by enhanced peripheral binder film structures. Enhanced peripheral binder film structures are observed for the PEF media of the invention in some alternative embodiments when the same amount of binder is applied both to a hydrophobic media (that is, to form a PEF media) and to a media that differs from the PEF media only in that it does not have a hydrophobic agent applied thereto (that is, a conventional media). Thus, in some such alternative embodiments, the binder resin present at the periphery of the PEF media exhibits films extending across gaps between individual fibers, whereas the conventional media exhibits no such film formation. In such alternative embodiments, the conventional media appear in some cases to have binder present significantly or substantially only on and along fiber surfaces, wherein the fiber to fiber bonding appears to be gained where the fibers were in contact during drying of the binder. In contrast, in some such alternative embodiments, the PEF media exhibit a significant amount of binder resin film structure wherein a film of binder resin extends between fibers over distances corresponding to at least the thickness of one fiber. The presence of such enhanced peripheral binder films in a PEF media of the invention depend on the nature of the fibers, the hydrophobic agent employed, and the type and amount of binder resin added to the media, as will be appreciated by one of skill.

Binder resins include any of the binder resins conventionally employed in forming filter media that are delivered in a liquid vehicle, including emulsions, dispersions, and solutions. Conventionally employed binder materials are employed for their ability to build fiber-to-fiber adhesion in the nonwoven media, thereby increasing tensile strength, decreasing compressibility, and the like. For such applications, useful binder resins include waterbased acrylic latexes, polyurethane dispersions, epoxy resins, and phenolic resins. Additionally, fluorochemical or silicone resins are useful in some embodiments as binder resins useful in forming the PEF media of the invention. In some such embodiments, the fluorochemical resins do not provide a significant amount of fiber-to-fiber adhesion, but rather function to provide a selected level of oleophobicity to the nonwoven media. Other polymeric binder resins are employed for a variety of selected functions.

In some embodiments, the binder resins are delivered in a waterbased emulsion or dispersion, and are dried by evaporating the water to coalesce and/or cure the resin. In other embodiments, the binder resins are delivered from a solvent other than water. Useful water-based acrylic latexes include but are not limited to substituted polycarboxylic acid or styrene acrylate polymers sold under the trade name ACRONAL® or ACRODUR® by BASF of Charlotte, N.C.; acrylic or styrene acrylic copolymer emulsions sold under the trade names CARBOCURE®, CARBOSET®, or HYCAR® by Lubrizol Corp. of Wickliff, Ohio; acrylic and hybrid acrylic/urethane emulsions sold under the trade designations of e.g. PD 2085-A2, PD-8176, PD 3808, PD 2045-H, 3160K, NF-3, NF-4, and PD-0466 by H. B. Fuller of St. Paul, Minn.; and acrylic latexes sold under the trade names AIRFLEX 4530 and 810 by Air Products of Allentown, Pa. Useful polyurethane based binder resins include but are not limited to those sold under the trade name SANCURE® by Lubrizol; SOLUCOTE® by Royal DSM of Heerlen, the Netherlands; WITCOBOND® by Chemtura of Middlebury, Conn.; and PD 4009, PD 4044, and PD 2104 by H. B. Fuller. Useful epoxy based binder resins include but are not limited to those sold under the trade name EPI-REZ® by MOMENTIVE® Performance Materials Inc. of Columbus, Ohio; and PN 2072 T4 by H. B. Fuller. Useful phenolic based binder resins include but are not limited to those sold under the trade name RESI-MAT® by Georgia Pacific of Decatur, Ga.; and AROFENE® by Ashland Chemical Co. of Columbus, Ohio Useful fluorochemical binder resin dispersions include but are not limited to fluoropolymer resins and fluoroelastomers such as those sold by the 3M Co. of St. Paul, Minn.; one example of a fluoropolymer resin is PM-490.

The total amount of binder resin present in the PEF media is not particularly limited and is selected based on the selected application and binder resin selected. In some embodiments, between 10% and 20% dry weight of binder compared to the total weight of the dry PEF media is present in the peripheral region. In some embodiments, optimal performance of the PEF media is observed where less than 10% by dry weight of binder compared to the total weight of the dry PEF media is present, for example between 0.1% and 9.9%, or 1%, 2%, 3%, 4%, 5%, 6%, 7%, 8%, or 9% or in any range spanning any individual values between 0.1% and 9.9% in 0.1% increments, for example ranges such as about 0.3% to 1.7%, about 4.5% to 9.8%, about 8.0% to 8.2%, and the like, as provided herein to describe the dry weight of binder as a percent of the total weight of the dry media. In some embodiments the weight percent of the binder includes one or more additional binder materials as described below, but in other embodiments the one or more additional binder materials are present in addition to the binder weight.

In some embodiments, the one or more bulk regions of the PEF media have higher overall permeability, lower solidity, and/or higher load capacity than the periphery which in turn serves to increase functionality of the bulk in entrapping and/or retaining components of the filtered fluid streams during a targeted filtration application. In some embodiments, the PEF media are simply an otherwise unbound mat of fibers, wherein the only fiber anchoring within the media is provided by the binder within the periphery. In some embodiments, the presence of enhanced peripheral binder film formation provides enhanced fiber anchoring at the periphery. Additionally, in some embodiments, the presence of the binder in one or more peripheral regions provides an improved ability to shape the PEF media. Increased ability of the PEF media to hold a selected shape is provided by increased stiffness of the one or more peripheral regions when binder is enriched in the one or more peripheral regions, or where enhanced peripheral binder film formation is observed, or both. Thus, for example, a PEF media is wound, pleated, or otherwise conformed to a selected shape, wherein the peripherally enriched binder or the enhanced peripheral binder film formation provides a source of increased strength at the periphery while the bulk remains unrestrained and pliable. Thus, the ability to shape the media, and the ability to retain the imposed shape of the media, is enhanced by virtue of the one or more peripheral regions.

In embodiments, filter elements formed from the PEF media include stacked or wound constructions wherein multiple layers of PEF media are employed in a filter element. In other embodiments, a single layer of the PEF media is employed in a filter element. In any such embodiments, additional element features are employed without limitation, for example scrims, wires, or other support features; housings, frames, and the like. The filter elements of the invention are not particularly limited as to the features employed in conjunction with the one or more layers of PEF media. In some embodiments, one or more articles associated with a filter element, for example a scrim or a frame, are bound directly to the PEF media by operation of the binder resin drying at the periphery of the media while the filter element article contacts the binder resin.

### 3. Methods of Making PEF Media

The PEF media are formed from nonwoven fibrous media. As such, any nonwoven fibrous media formed generally by any conventional process known for making nonwoven media is adaptable to form the PEF media of the invention. Air laid methods, wet laid methods, melt blown methods, electrospun methods, carding methods, needling methods, needlepunch methods, spunbond methods, or any other methods of making or modifying a nonwoven media are usefully employed in conjunction with making the PEF media of the invention. It will be understood that in general, any of the materials described above are usefully employed in one or more methods described below to result in a PEF media of the invention; one of skill will understand that judicious selection of materials for compatibility with the selected process is necessary in order to successfully form a PEF media.

The PEF media are made by adding the hydrophobic agent to the fibers or to formed nonwoven fibrous media, and subsequently adding the binder resin and optional additional binder materials to the formed nonwoven media having the hydrophobic agent present therein. Differences in methodology employed to make the PEF media are realized principally in the method of adding the hydrophobic agent. Addition of the hydrophobic agent is suitably carried out using one of at least three distinct types of methods, including variations thereof that will be apparent to the skilled artisan. In a first type of method, a hydrophobic agent is added to fibers during the fiber making process (i.e. during polymer processing to form fibers) that in turn are used to form the non-woven fibrous media. In a second type of method, the hydrophobic agent is added to a fiber or mixture of fibers and the fibers are used to form the non-woven fibrous media. In a third type of method, the hydrophobic agent is added to a formed nonwoven fibrous media. In all three methodologies, the binder resin is added to the hydrophobic media, further using conventional techniques.

In the first type of method, hydrophobic agent is added to fibers during the fiber making process. This method is suitably employed where the polymer processing methodology employed to form fibers is suitably adapted to the addition of the hydrophobic agent. Formation of thermoplastic fibers, in particular fibers formed from synthetic thermoplastic materials such as polyolefins, polyesters, polyamides, polyvinyl chloride, acrylics, and the like are particularly well suited for addition of the hydrophobic agent during fiber formation. Melt blowing, melt spinning, electrospinning, and other fiber forming techniques wherein fibers are formed either using a thermal or solution mediated methodology are well suited for addition of a hydrophobic agent in conjunction with the fiber formation. In a representative example, thermoplastic fibers are formed by an extrusion process, wherein the hydrophobic agent is added to the extrusion mixture. In some such embodiments, the hydrophobic agent is a small molecule or an oligomer that is capable of “blooming” to the surface of the molten thermoplastic polymer due to a tendency to phase separate, and lowers the surface energy of the fiber surface by residing principally at or near the surface thereof upon cooling of the fiber. In other embodiments, the hydrophobic agent remains impregnated throughout the thermoplastic fiber article, with a portion of the agent residing at the surface thereof, in an amount sufficient to lower the surface energy of the thermoplastic.

Examples of thermal processes suitable for making fibers having a hydrophobic agent added thereto include melt spinning or extrusion spinning as well as drawing, wherein the fibers are formed by stretching a molten or partially solidified mass to decrease diameter, orient the polymer chains, and increase tensile strength of the resulting fiber. Examples of solvent mediated processes suitable for making fibers having a hydrophobic agent added thereto include wet spinning, dry spinning, gel spinning, and electrospinning. In some embodiments where wet spinning is employed, the hydrophobic agent is suitable included in either the solvent employed to dissolve the polymer, or in the solvent employed to precipitate the polymer, depending on the nature of the hydrophobic agent and ability of the agent to adhere to the surface of the fiber during precipitation. In dry spinning, gel spinning, and electrospinning methodologies the hydrophobic agent is added to the polymer solution and is further selected so as not to evaporate during the drying of the fibers.

In the second type of method, the hydrophobic agent is added to the formed fiber or mixture of fibers and the fibers are used to form the non-woven fibrous media. While not limited thereto, in embodiments this type of method is particularly well suited for use with natural fibers such as cellulosics; or for fibers not well suited for thermal or solvent blending of the hydrophobic agent with the fiber material, such as metal or ceramic fibers. In some embodiments, the hydrophobic agent is added to a fiber by providing a solvent bath containing the hydrophobic agent, through which the fiber is passed prior to formation of the nonwoven media. In another example, a plasma or spray application of the hydrophobic agent is applied to the fibers. Such fibers, pre-treated with the hydrophobic agent, are suitable for use in e.g. air laid, or dry laid (carding) processes. In some embodiments, the hydrophobic agent is added contemporaneously during media formation; that is, the fibers are not pre-treated. Suitable examples of contemporaneous media formation and hydrophobic agent addition include processes adapted for dry laid and wet laid processes. In dry laid processes, for example, the hydrophobic agent is used in some embodiments to coat the carding machine components that contact the fibers during carding of the staple fibers, for example by partially immersing a rotating carding drum in a solution containing the hydrophobic agent. In wet laid processes, for example, the hydrophobic agent is dispersed in the fiber slurry that is subsequently deposited on a screen, whereupon the liquid is drained to leave the nonwoven fibrous media having some portion of the hydrophobic agent dispersed therein.

In the third type of method, the hydrophobic agent is added to a nonwoven fibrous media after media formation. This method is suitably employed with any formed nonwoven fibrous media. In various embodiments the media is dipped in a solution or dispersion containing the hydrophobic agent; sprayed or brushed with a solution or dispersion containing the hydrophobic agent; or otherwise contacted with the hydrophobic agent using any means suitably adapted for the user's convenience and cost effectiveness. In some embodiments, a pretreatment such as corona treatment is desirably carried out prior to addition of the hydrophobic agent in order to incur adhesion of the hydrophobic agent to the web.

A nonwoven fibrous media having one or more hydrophobic agents, but not a binder resin applied thereto is a hydrophobic media. The binder resin is added to the hydrophobic media and dried to result in the PEF media of the invention. The binder resin is applied in a solution or dispersion in a solvent; in many embodiments the solvent is water. In various embodiments, the binder resin is applied using any of the standard techniques employed in the industry. For example, binder is suitably applied by dipping or spraying followed by removal of excess binder by gravity draining, vacuum suction, nip roll squeezing, and the like.

Drying of the binder remaining in the nonwoven media is carried out using standard industrial techniques such as convection oven drying, heated platen or drum drying, and the like. In some embodiments the binder migrates toward the periphery of the media by virtue of the lowered surface energy of the fibers imparted by the presence of the hydrophobic agent on the surface thereof, further as aided by capillary pressure. It will be understood that when the same amount of binder is applied to a nonwoven media without the hydrophobic agent present, the PEF media of the invention will not result, because capillary pressure is insufficient to give rise to the observed differences of peripheral binder enrichment, peripheral enhanced binder film structure, or both. Rather, an uneven distribution of binder results in some cases where no hydrophobic agent is present during binder addition and drying. In some embodiments, the presence of the hydrophobic agent is sufficient to prevent the solution, emulsion, or dispersion of binder resin from being retained in the interior of the hydrophobic media in the liquid form. In some such embodiments, this is true even where the hydrophobic media is completely immersed in the binder solution, emulsion, or dispersion; in such cases, the liquid quickly dewets from the media interior once the media is removed from the immersion bath containing the binder. In some such embodiments, after the media is dry it is possible to observe a very clean, binder-free bulk that has significantly or substantially no binder material at all. In some embodiments, the presence of the hydrophobic agent gives rise to the formation of enhanced peripheral binder film structures, that is, binder films that extend across the gaps between fibers of the nonwoven media.

In various embodiments, careful selection of the hydrophobic agent and selection of the weight percent hydrophobic agent imparted to the fibrous media enables control of the binder placement and/or film structure during the addition and drying thereof. That is, in various embodiments, selection of the hydrophobic agent type and amount leads to at least one of: dewetting of the selected binder solution, emulsion, or dispersion from the fibers prior to drying; migration to the periphery of the media during drying; and formation of enhanced peripheral binder film structures. In the various embodiments, the interplay between fiber, hydrophobic agent, and binder allow a controlled placement of binder, a controlled binder film structure, or both.

In a very few embodiments, the fibers themselves have sufficiently low surface energy such that it is not necessary to add a hydrophobic agent thereto in order to form the PEF media; rather, binder added directly to such media is sufficient to form the PEF media. In embodiments, such fibers include fluoropolymer fibers and polydialkylsiloxane fibers. In such embodiments, it is an advantage of the PEF media of the invention that the binder residing significantly, or substantially in the periphery results in the ability to employ and fully realize the properties of the bulk region fibers themselves. Thus, for example, the oleophobicity imparted by fluoropolymer fibers are fully realized by providing a media having a bulk region substantially free from a binder coating.

In some embodiments, one or more techniques are employed in order to dispose the hydrophobic agent in a gradient fashion or within only a portion of the nonwoven media prior to addition of the binder resin thereto. In such embodiments, controlled placement of the binder resin results in variations of the final PEF media structure. In some such embodiments, a single peripheral region including only one of the two major surfaces of the nonwoven fibrous media results from the drying of the binder resin. In other embodiments, two or more peripheral regions are formed but with differential placement of the binder; that is, one peripheral region includes a greater portion of the area contiguous to the surface when compared to a second peripheral region. Such differential placement of binder is suitably brought about by, for example, using fibers treated with a hydrophobic agent and fibers with no hydrophobic agent to form a gradient media by a wet laid process using the procedures outlined in U.S. Patent Publication No. 2010/0187171.

In embodiments, filter elements formed from the PEF media include stacked or wound constructions wherein multiple layers of PEF media are arranged within a single filter element. In other embodiments, a single layer of the PEF media is arranged to provide a filter element. In some embodiments, the formation of PEF media, specifically the addition of binder resin, is suitably carried out in the presence of one or more features of a filter element, and the binder resin serves in part to adhere the one or more filter elements to the PEF media. For example, in a representative embodiment, a plastic, glass, or wire scrim is contacted with a major surface of a hydrophobic media prior to addition of the binder resin to the media. Then the hydrophobic media and scrim construction is contacted with binder resin. As the binder resin is dried, the scrim becomes adhered to, or encompassed within, the peripheral region that include the major surface upon which the scrim was contacted. Other similar examples are easily envisioned by one of skill, wherein one or more non-media articles, such as non-media filter element components, are contacted with an exterior surface of a hydrophobic media and are employed in the subsequent process of adding binder resin to the media such that upon drying, the articles are incorporated within the PEF media structure.

### 4. Properties and Performance of PEF Media

In some embodiments, the periphery of the PEF media is enriched in a binder resin, including any optional additional binder materials, whereas the bulk is significantly or substantially free of that binder resin, or in embodiments has a significantly or substantially lower concentration of binder resin compared to the periphery. In other embodiments, the periphery of the PEF media has an enhanced binder film structure. In still other embodiments, the PEF media is both enriched in binder resin, and has an enhanced peripheral binder film structure. These structural differences lead to observable differences in performance when the PEF media is compared to conventional media.

In some embodiments, the PEF media includes one or more bulk regions that are substantially free of binder, so that the fibers therein provide maximum loading capacity and efficiency with low pressure drop. In some embodiments, the PEF media periphery provides robust tensile strength associated with enhanced fiber to fiber bonding. It is a further advantage that in providing tensile strength and fiber binding properties to the periphery, the binder is present in minimal amounts in terms of overall weight percent in the media. As is discussed above, in some embodiments, optimal performance of the PEF media is observed where less than 10% by dry weight of binder compared to the total weight of the dry media is present. However, in some embodiments, it may be advantageous to include more binder, due to performance parameters in a particular application. In some embodiments, optimal performance is retained at both higher and lower amounts of binder in the PEF media, whereas a conventional media suffers performance setbacks at higher or lower amounts of binder.

For example, by way of illustration, two media having 10 wt % binder are compared, where one media is a PEF media and the other is a conventional media such as in the alternative example discussed above. Decreasing the total amount of binder could, for example, result in fiber sloughing from the surface of the conventional media, whereas the surface of the PEF exhibits reduced or eliminated fiber sloughing. Further to the alternative example, increasing the total amount of binder could result in the conventional media losing substantial efficiency, as is known to occur in conventional media when more binder is added. The PEF media, however, are characterized by maintenance of high efficiency even as more binder is added to the media. Thus, the PEF media of the invention allow for optimal performance in a range of modes and in a number of different applications as will be appreciated by one of skill.

Performance advantages are also observed where the PEF media are pleated, or stacked or rolled, for inclusion in a filter element as such media are commonly employed. One advantage is that the overall media weight is less, in some embodiments, by employing the PEF media compared to a conventional media due to the overall reduction in weight of binder material present over a series of layers in the stacked or rolled construction. Additionally, it is possible in some embodiments to employ a single layer of PEF media in a targeted filtration application since a single layer of the filter media has multiple functionality, which in turn is due to the novel and characteristic differences between the periphery and the bulk in a single media layer afforded by the PEF structure. Such differences include, in some embodiments, an enhanced peripheral binder film structure.

The properties of the bulk of the PEF media are, in some embodiments, defined by one or more of pore size, compressibility, permeability, solidity, basis weight, efficiency, and load capacity. In various embodiments, one or more of these properties differ between the one or more peripheral regions and the bulk, by virtue of the presence of binder resin, presence of enhanced peripheral binder film structure, or both. Pore size referred to in this disclosure means mean flow pore diameter determined using a capillary flow porometer instrument such as Model APP 1200 AEXSC sold by 40 Porus Materials, Inc., Cornell University Research Park, Ithaca, N.Y. In some embodiments, the pore size of the bulk media is about 0.1 μm to 1000 μm, about 100 μm to 1000 μm, about 100 μm to 500 μm, about 200 μm to 700 μm, about 0.5 μm to 100 μm, about 0.2 μm to 50 μm, about 0.2 μm to 100 μm, about 5 μm to 100 μm, about 10 μm to 30 μm, about 5 μm to 50 μm, about 0.5 μm to 10 μm, about 0.5 μm to 30 μm, or about 5 μm to 20 μm. In some embodiments, pore size of the one or more peripheral regions, compared to the bulk, is the same as, or substantially the same as, the pore size of the bulk. In other embodiments, the pore size of the one or more peripheral regions is decreased compared to the bulk. In some such embodiments, the pore size is decreased by about 5% to 50%, or about 10% to 30%, or about 5% to 10%, or about 5% to 20%, or about 10% to 25% compared to the pore size of the bulk.

Compressibility is a comparison of two thickness measurements made using the dial comparator, with compressibility being the relative loss of thickness from a 56.7 g to a 255.2 g total weight (8.6 millibars-38.8 millibars). In various embodiments, the compressibility of the bulk is 75% to 2%, or 50% to 5%, or 25% to 1% between 0.125 and 0.625 lb/in². In some embodiments, the compressibility of the one or more peripheral regions, compared to the bulk, is substantially the same as the compressibility of the bulk. In other embodiments, the compressibility of the one or more peripheral regions is decreased compared to the compressibility of the bulk. In some such embodiments, the compressibility is decreased by about 5% to 50%, or about 10% to 30%, or about 5% to 10%, or about 5% to 20%, or about 10% to 25% compared to the compressibility of the bulk. It will be appreciated that a decreased compressibility, evidence of increased mechanical strength of the media in the one or more peripheral regions, is dependent on the nature of the binder resin as well as the amount and/or type of fiber to fiber bonding achieved by the binder resin.

In various embodiments, the Frazier permeability of the bulk, as determined according to ASTM D737, is about 5 to 500 ft/min, or about 2 to 200 ft/min, or about 20 to 200 ft/min, or about 50 to 500 ft/min, or about 0.1 to 30 ft/min, or about 5 to 200 ft/min, or about 1 to 200 ft/min, or about 2 to 500 ft/min, or about 0.1 to 1000 ft/min, or about 2 to 900 ft/min, or about 200 to 1000 ft/min. In some embodiments, the permeability of the one or more peripheral regions, compared to the bulk, is the same as, or substantially the same as, the permeability of the bulk. In other embodiments, the permeability of the one or more peripheral regions is decreased compared to the permeability of the bulk. In some such embodiments, the permeability is decreased by about 5% to 75%, or about 10% to 50%, or about 5% to 30%, or about 5% to 20%, or about 10% to 25% compared to the permeability of the bulk. It will be appreciated that the amount of any decrease in permeability in the one or more peripheral regions is dependent on the amount and/or type of fiber to fiber bonding achieved by the binder resin and the total amount of binder resin present in a peripheral region.

In various embodiments, the solidity of the bulk is about 0.1% to 30%, or about 2% to 25%, or about 10% to 25%, or about 1% to 10%, or about 2% to 10%. In various embodiments, the basis weight of the bulk is about 1 to 2000 g/m², or about 10 to 1000 g/m², or about 2 to 200 g/m², or about 20 to 200 g/m², or about 40 to 400 g/m², or about 20 to 100 g/m², or about 10 to 50 g/m², or about 40 to 350 g/m². In some embodiments, the solidity of the one or more peripheral regions, compared to the bulk, is the same as, or substantially the same as, the solidity of the bulk. In other embodiments, the solidity of the one or more peripheral regions is increased compared to the solidity of the bulk. In some such embodiments, the solidity is increased by about 5% to 75%, or about 10% to 50%, or about 5% to 30%, or about 5% to 20%, or about 10% to 25% compared to the solidity of the bulk. It will be appreciated that the amount of any increase in solidity in the one or more peripheral regions is dependent on the total amount of binder resin present in a peripheral region.

In liquid filtration, beta testing (β testing) is a common industry standard for rating the efficiency of filters and filter performance. The beta test rating is derived from Multipass Method for Evaluating Filtration Performance of a Fine Filter Element, a standard method (ISO 16899:1999) The β test provides a beta ratio that compares downstream fluid cleanliness to upstream fluid cleanliness. To test the filter, particle counters accurately measure the size and quantity of upstream particles for a known volume of fluid, as well as the size and quantity of particles downstream of the filter for a known volume of fluid. The ratio of the particle count upstream divided by the particle count downstream at a defined particle size is the β ratio. The efficiency of the filter can be calculated directly from the β ratio as (β−1)/β×100). Using this formula one can see that a β ratio of two indicates a % efficiency of 50%; a β ratio of 10 indicates 90% efficiency, a β ratio of 200 indicates 99.5% efficiency, and so on. In some embodiments, the bulk efficiency corresponds to a β ratio of about 10 to 500, or about 25 to 200, or about 100 to 500, or about 100 to 200, or about 100 to 300, where particles between 1 and 15 μm are employed in the β test. In some embodiments, the PEF media have efficiency of greater than 90%, for example 95% to 99.99%, for particles of 0.18 μm count median diameter (CMD) at a velocity of 5.33 cm/s. In some embodiments, the efficiency of the one or more peripheral regions, compared to the bulk, is the same as, or substantially the same as, the solidity of the bulk. It will be appreciated that the change in efficiency in the one or more peripheral regions is dependent on the total amount of binder resin present in a peripheral region as well as the presence of enhanced peripheral binder film structure.

A figure of merit (Fμ) parameter is used in some embodiments to illustrate the overall performance advantages of the PEF media of the invention in a typical filtration application. The object of Fμ is to compare performance between different filter media. To this end, Fμ for filtration is a function of permeability and penetration of a particular type and controlled size range particle from a fluid stream flowing through the media at a controlled rate. “Penetration” is a function of both particle size and velocity of the particles; when normalized, penetration indicates the fraction of particles of the selected size that proceed through the media and are detected on the exit side thereof at the selected particle velocity. Fμ is calculated as

Fμ=−Log(Penetrationₙ)*permeability*f

### Where

Penetrationₙ is normalized penetration for a selected size of particles at a selected velocity
Permeability, measured at selected pressure drop
f is a conversion factor
   Penetration is related to efficiency in that, for normalized penetration (or penetration fraction), penetration=(1−normalized efficiency). Using Fμ as a measure of suitability for filtration in general, the PEF media of the invention retain performance, in embodiments, as more and more binder is applied to the media, while conventional media suffer a decrease in Fμ over the same range of binder amount present in the media overall. In some embodiments, the superior Fμ of the PEF media are attributable to the fact that the PEF media are not observed to decrease in efficiency as more binder is added, or are observed to decrease only slightly in efficiency as more binder is added, while conventional media are observed to have strongly decreased efficiency with increasing amount of binder. Thus, in some embodiments, the PEF media of the invention having about 5 wt % to 20 wt % binder resin based on the weight of the dry fibers retain at least 75% of the Fμ value corresponding to the media without binder; or Fμ values that are at least about 80% to 99%, or 80% to 95%, or 80% to 90% of the Fμ value corresponding to the media without binder. The same fibrous media without the hydrophobic agent added, and having the same total percent binder resin added as the PEF media (that is, a conventional fibrous media), have Fμ values of less than 75%, in some embodiments, of the Fμ value corresponding to the media without binder; or Fμ values that are about 75% to 5%, or 70% to 20%, or 60% to 40% of the Fμ value corresponding to the media without binder. In one representative example, where Fμ is greater than or equal to 100 for media with no binder resin, the PEF media retain a measured value of Fμ of equal to or greater than 100 when a total of 0.1 wt % to 30 wt % of binder resin is applied to the PEF media based on the fiber weight of the media, or 0.5 wt % to 20 wt % of binder resin is applied to the PEF media based on the fiber weight of the media, or 1 wt % to 10 wt % of binder resin is applied to the PEF media based on the fiber weight of the media. For the same media that is not PEF media (that is, where the binder resin is added to media that is not hydrophobic media), the same weight percent application of binder results in Fμ values falling from greater than or equal to 100 for the media with no binder, to about 90 to 30, or about 90 to 40, or about 90 to 50, or about 80 to 50.

The PEF media are useful, as a single layer or in multiple layers thereof, in a range of filtration applications. Such filtration application include gas filtration, for example, air filtration, natural gas filtration, exhaust filtration, crankcase ventilation filtration, filtration of industrial gases such as Ar, N₂, CO₂, and the like; and liquid filtration, for example, water filtration, fuel filtration, oil filtration, biomass product filtration, filtration of industrially useful chemicals, and the like.

### Experimental Section

Materials used in the various Examples are listed in Table 1.

TABLE 1
Materials used in the following Examples.

| Material | Material Information | Source or Manufacturer |
|---|---|---|
| K-137 | Chopped borocalcium alumina | Johns Manville, Waterville, |
| | silicate (Type E glass) fiber | OH |
| B-08 | Borosilicate glass fiber, 0.8 μm | Lauscha Fiber International, |
| | diameter | Summerville, SC |
| B-50 | Borosilicate glass fiber, 5 μm | Lauscha Fiber International |
| | diameter | |
| 271P | DUPONT ® 271P Polyester | DuPont de Nemours and Co., |
| | staple fiber | Wilmington, DE |
| Nalco | NALCO ® 7468 silica based | Nalco Holding Co., |
| 7468 | defoamer | Naperville, IL |
| TJ04BN | TEIJIN TETORON ® TJ04BN | Teijin Fibers Ltd., Osaka, |
| | SD 2.2 × 5 Polyester/copolyester | Japan |
| | bicomponent fiber | |
| Hycar | HYCAR ® 26921 Acrylic | Lubrizol Corp., Wickliff, |
| 26921 | emulsion | OH |
| Epi-Rez | EPI-REZ ® Resin 3519-W-50 | MOMENTIVE ® Specialty |
| | solution | Chemicals, Inc., Columbus, |
| | | OH |
| Epikure | EPIKURE ® Curing Agent | MOMENTIVE ® Specialty |
| | 3295 | Chemicals, Inc. |
| PM-490 | Nonionic fluorochemical | 3M Co., St. Paul, MN |
| | resin solution | |

Tests used in the various Examples are as follows.

1. Permeability. A sample at least 38 cm square is cut from a media to be tested. The sample is mounted on a TEXTEST® FX 3310 (obtained from Textest AG of Schwerzenbach, Switzerland). Permeability through the media is measured using air, wherein ft³ air/ft² media/min or m³ air/m² media/min is measured at a pressure drop of 0.5 inches of water.

2. Hydrostatic Head Test. The media to be tested is subjected to a steadily increasing pressure of water until penetration occurs on the surface of the media. Three samples, each 35.5 cm square, are cut from a media to be tested. A sample is mounted on a TEXTEST® FX3000 Hydrostatic Head Tester II (obtained from Textest AG of Schwerzenbach, Switzerland), and the water reservoir of the tester is filled with deionized water. The water pressure gradient applied to the sample is set to 60 millibars/min. The reported number is the time elapsed from the start of the test until 3 water droplets are observed on the media surface, or alternatively as the pressure in millibars recorded at the end of the test.

3. Efficiency. This is a measurement of the fraction of particles that are entrapped by a filtration media. In some cases, efficiency is reported as a percent, and efficiency=(100−% penetration). For normalized efficiency, efficiency=(1−penetration). Penetration is discussed below.

4. Penetration. This is a measurement of the fraction of particles that proceed through a filtration media and are measured on the exit side of the media, reported as fraction (normalized) or percentage, as measured and reported in a format presented by the onboard digital system of a Penetrometer TDA-100P (obtained from Air Techniques International of Owings Mills, Md.). For the measurements reported below, particle size of 0.18 μm count median diameter (CMD) was used at a velocity of 5.33 cm/s.

5. Resistance is a function of pressure drop, and is a value reported during penetration tests run on the Penetrometer TDA-100P (obtained from Air Techniques International of Owings Mills, Md.).

### Examples 1-8

A kitchen blender was charged with 1 liter of deionized water, and the pH was adjusted to about 3 using sulfuric acid. Then K-137 fibers were added to the blender and the contents were mixed at the “liquefy” setting on the blender for about 30 seconds. The blender was opened and B-08 fibers and B-50 fibers were added to the blender and the contents were mixed at the “liquefy” setting on the blender for about 60 seconds. The blender was opened and 271P fibers were added to the blender and the contents were mixed at the “liquefy” setting on the blender for about 15 seconds. In this manner, a mixture having a dry weight percentages corresponding to 22.5% K-137, 21.5% B-08, 36% B-50, and 20% 271P was formed. Then the blender was opened and Nalco 7468 was added at in an amount corresponding to a selected wt % of Nalco 7468 as received based on the dry weight of the fibers, as indicated in Table 2. The blending was repeated for each of Examples 1-8. Then each blended mixture was poured into a 30.5 cm×30.5 cm handsheet mold used to make paper handsheets, and handsheet mats were formed using standard papermaking techniques. The mats were dried using an Emerson Apparatus Model 135 heated press (obtained from Emerson Apparatus, Inc. of Gorham, Me.) set at a temperature of 127° C. by placing the mat on the bottom (heated) platen, closing the apparatus, allowing the temperature of the bottom platen to return to 127° C., leaving the apparatus closed for an additional 60 seconds; opening the apparatus, flipping the mat over, closing the apparatus, allowing the temperature of the bottom platen to return to 127° C., then leaving the mat in the apparatus for an additional 60 seconds before removing the mat from the apparatus. After the mats had cooled to ambient temperature, the basis weight of each of the mats were determined; this is reported as Initial basis weight in Table 2. Each of the mats was tested for permeability, penetration, resistance, hydrostatic head, and efficiency (calculated from penetration). The results are reported as “initial” results in Table 3.

Then each of the mats was immersed for about 6 seconds in a pan containing water, 1.18 wt % Hycar 26921 solids, and 0.5 wt % of Blaze Orange pigment AX-15 (Product Code AX-15-N obtained from Day-Glo Color Corp.) based on the weight of the Hycar solids. Fresh Hycar 26921 mixture was provided for each soaking, in an amount sufficient to completely immerse the mat. Upon removing each mat from the pan, the mats were allowed to drain by holding the mats vertically until binder dispersion nearly stopped running out. Then the mats were secured on a glass scrim over a metal mesh in a convection oven set to 135° C. for about 3 minutes. After the mats had cooled to room temperature, the final basis weight (after resin soak/dry) and % resin pickup (percent increase in the dry weight of the mat compared to the weight of the mat prior to soaking in Hycar 26921 mixture) of each of the mats was determined. The results are shown in Table 2. The mats were tested for hydrostatic head prior to adding Hycar 26921 and were measured for permeability, efficiency, and resistance both before adding Hycar 26921 (initial) and after adding Hycar 26921 (final). The results are shown in Table 3.

TABLE 2
Amount of Nalco 7468 added as received to fibrous media and
resulting resin pickup. Nalco 7468 was added to the slurry
in wt % as received, based on the total dry fiber weight.

| | | | | Resin pickup, |
|---|---|---|---|---|
| | Nalco 7468, | Initial basis | Final Basis | % based on |
| Example | wt % | wt, g/m² | wt, g/m² | initial weight |
| 1 | 1 | 108.06 | 117.01 | 8.37 |
| 2 | 1.5 | 109.37 | 115.83 | 5.91 |
| 3 | 2 | 106.36 | 111.51 | 4.86 |
| 4 | 3 | 110.65 | 116.25 | 5.06 |
| 5 | 4 | 107.64 | 111.09 | 3.20 |
| 6 | 5 | 105.49 | 108.93 | 3.27 |
| 7 | 6 | 104.63 | 107.64 | 2.88 |
| 8 | 7 | 102.46 | 105.05 | 2.52 |

TABLE 3
Results of testing before addition of Hycar 26921 (initial) and after addition and
drying of Hycar 26921 (final).

| | Example | | | | | | | |
|---|---|---|---|---|---|---|---|---|
| Test Result | 1 | 2 | 3 | 4 | 5 | 6 | 7 | 8 |
| Hydrostatic Head, | 6 | 7 | 7 | 8 | 20 | 21 | 27.5 | 27 |
| in. H₂O, initial | | | | | | | | |
| Permeability, | 3.69 | 3.60 | 3.57 | 3.72 | 3.69 | 3.78 | 3.72 | 3.78 |
| m³/m²/min, initial | | | | | | | | |
| Permeability, | 2.98 | 3.14 | 3.32 | 3.32 | 3.81 | 3.72 | 3.81 | 3.90 |
| m³/m²/min, final | | | | | | | | |
| Penetration, %, | 1.139 | 0.900 | 0.930 | 1.016 | 1.003 | 1.259 | 1.109 | 1.082 |
| initial | | | | | | | | |
| Penetration, %, final | 2.552 | 1.766 | 1.602 | 1.408 | 1.39 | 1.641 | 1.521 | 1.504 |
| Efficiency, %, initial | 98.86 | 99.10 | 99.07 | 98.98 | 99.00 | 98.74 | 98.89 | 98.92 |
| Efficiency, %, final | 97.45 | 98.23 | 98.40 | 98.59 | 98.60 | 98.36 | 98.48 | 98.50 |
| Resistance, in. H₂O, | 0.512 | 0.523 | 0.526 | 0.503 | 0.507 | 0.493 | 0.498 | 0.489 |
| initial | | | | | | | | |
| Resistance, in. H₂O, | 0.605 | 0.583 | 0.554 | 0.552 | 0.494 | 0.494 | 0.485 | 0.470 |
| final | | | | | | | | |

### Examples 9-20

A fiber slurry was formed as follows. A lab mixer equipped with a pitched blade propeller was charged with 2.7 liters of water, and sulfuric acid was added to adjust the pH of the water to about 3. Then K-137 fibers were added and the contents of the mixer were stirred for 1000 revolutions of the propeller. Then B-08 fibers and B-50 fibers were added, and the contents of the mixer were stirred for another 8000 revolutions of the propeller. Then TJ04BN fibers were added, and the contents of the mixer were stirred for another 1000 revolutions of the propeller. In this manner, a mixture having dry weight percentages corresponding to 30% K-137, 10% B-08, 45% B-50, and 15% TJ04BN was formed. In some Examples, Nalco 7468 was added to the mixer in amount corresponding to 2 wt % Nalco 7468 as received, based on the total dry weight of the fibers, and the contents of the mixer were stirred for another 200 revolutions of the propeller. The blending was repeated for each of Examples 9-20 to result in the fiber slurries.

Each fiber slurry was poured into a 30.5 cm×30.5 cm handsheet mold used to make paper handsheets, and handsheet mats were formed using standard papermaking techniques. The mats were dried using an Emerson Apparatus Model 135 heated press (obtained from Emerson Apparatus, Inc. of Gorham, Me.) set at a temperature of 104° C. by placing 0.16 cm wire spacers on the bottom platen, placing the mat on the bottom (heated) platen, closing the apparatus, allowing the temperature of the bottom platen to return to 104° C., leaving the apparatus closed for an additional 60 seconds; opening the apparatus, flipping the mat over, closing the apparatus, allowing the temperature of the bottom platen to return to 104° C., then leaving the mat in the apparatus for an additional 60 seconds, or until dry, before removing the mat from the apparatus. Then the mats were placed between polytetrafluoroethylene (PTFE) sheets 0.168 mm thick. Wire spacers 0.16 cm thick were placed on the bottom platen of a Model DK20S press (obtained from the Geo Knight Co., Inc. of Brockton, Mass.) modified to have both top and bottom heated plates and having both plates set to 160° C., and the sheet/mat combination was inserted into the apparatus for 3 minutes.

Epi-Rez was diluted in deionized water to a selected concentration, and EpiKure was added to yield a weight ratio of Epi-Rez to EpiKure of 54.43:1. For each Example, the amount of resin in the water was carefully adjusted to result in approximately the same weight percent of resin pickup between a mat having no Nalco 7468 and a mat having Nalco 7468, as will be appreciated in a comparison of % resin pickup in Table 4. The mixture was placed in a pan and 12.7 cm×12.7 cm sections of the mats, cut from the handsheet samples, were immersed in the liquid in the pan for about 6 seconds. The mats were drained by holding vertically until the Epi-Rez dispersion nearly stopped dripping from the mat, then dried by placing the mats between PTFE sheets 0.168 mm thick, then placing 0.25 cm spacers and the sheet/mat combination in the Model DK20S press, wherein both platens were set to 135° C., for 30 minutes. The mats were allowed to cool to room temperature before weighing to determine % resin pickup.

Initial basis weight (before addition of Epi-Rez/EpiKure), final basis weight (after addition of Epi-Rez/EpiKure and drying), weight percent of resin added to the mats, permeability, penetration, efficiency, and resistance were measured for the mats with and without Nalco 7468. The results are shown in Table 4.

TABLE 4
Components and properties of mats formed with no Nalco 7468 and with 2 wt %
Nalco 7468 added to the slurry as received, based on the total dry fiber weight.

| | | | | | | | | |
|---|---|---|---|---|---|---|---|---|
| | Epi- | Initial | Final | | | | | |
| | Rez, | Basis | Basis | Resin | | | | |
| Ex. | wt % in | wt, | wt, | pick | Permeability, | % | % | Resistance, |
| No. | H₂O | g/m² | g/m² | up, wt % | m³/m²/min | Penetration | Efficiency | in. H₂O |

0% Nalco 7468

| | | | | | | | | |
|---|---|---|---|---|---|---|---|---|
| 9 | 0 | 111.60 | 111.60 | 0 | 10.33 | 23.24 | 76.8 | 0.156 |
| 10 | 0.283 | 112.84 | 116.25 | 3.02 | 11.22 | 32.66 | 67.3 | 0.138 |
| 11 | 0.67 | 112.84 | 120.40 | 6.70 | 10.33 | 52.42 | 47.6 | 0.150 |
| 12 | 0.96 | 112.21 | 120.22 | 7.13 | 10.49 | 41.14 | 58.9 | 0.152 |
| 13 | 1.35 | 113.47 | 129.21 | 13.88 | 10.42 | 43.97 | 56.0 | 0.151 |
| 14 | 2.02 | 113.47 | 136.02 | 19.89 | 10.67 | 49.50 | 50.5 | 0.140 |

2 wt % Nalco 7468

| | | | | | | | | |
|---|---|---|---|---|---|---|---|---|
| 15 | 0 | 111.60 | 111.60 | 0 | 9.85 | 20.03 | 79.97 | 0.175 |
| 16 | 1.58 | 112.21 | 115.39 | 2.82 | 10.39 | 25.54 | 74.5 | 0.164 |
| 17 | 2.80 | 111.84 | 121.95 | 7.49 | 10.39 | 16.41 | 83.6 | 0.160 |
| 18 | 5.60 | 111.84 | 129.34 | 13.99 | 10.18 | 16.87 | 83.1 | 0.163 |
| 19 | 7.62 | 112.83 | 132.00 | 16.98 | 9.94 | 15.48 | 84.52 | 0.162 |
| 20 | 8.40 | 111.84 | 139.82 | 23.22 | 9.81 | 25.75 | 74.3 | 0.164 |

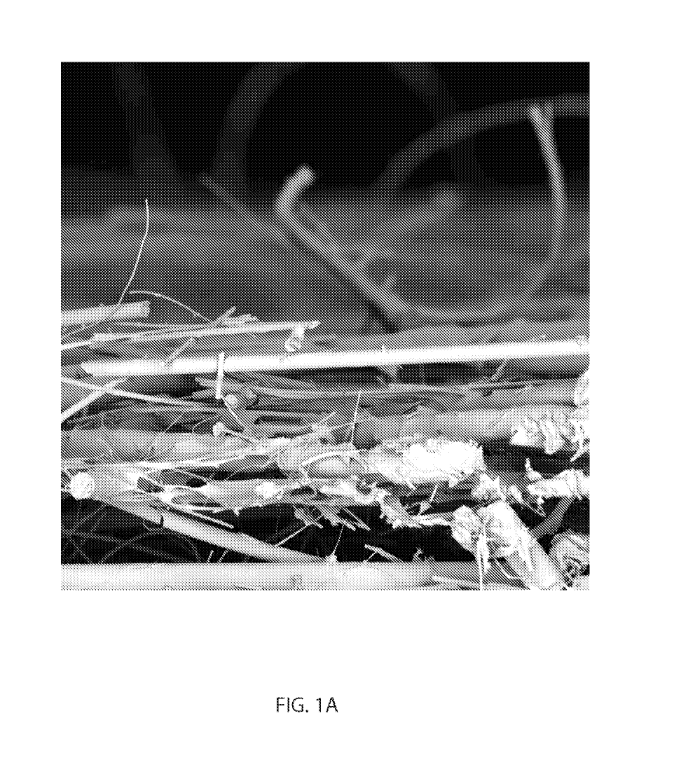

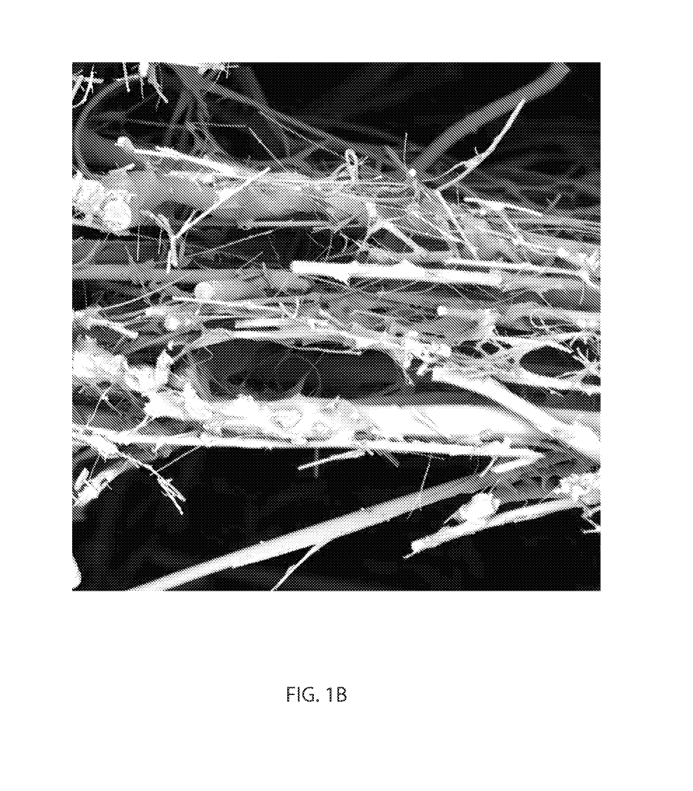

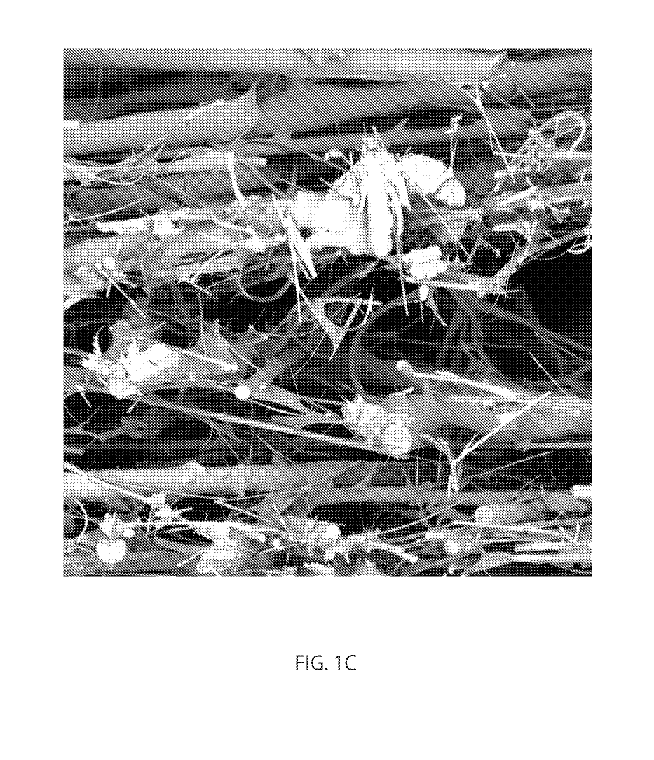

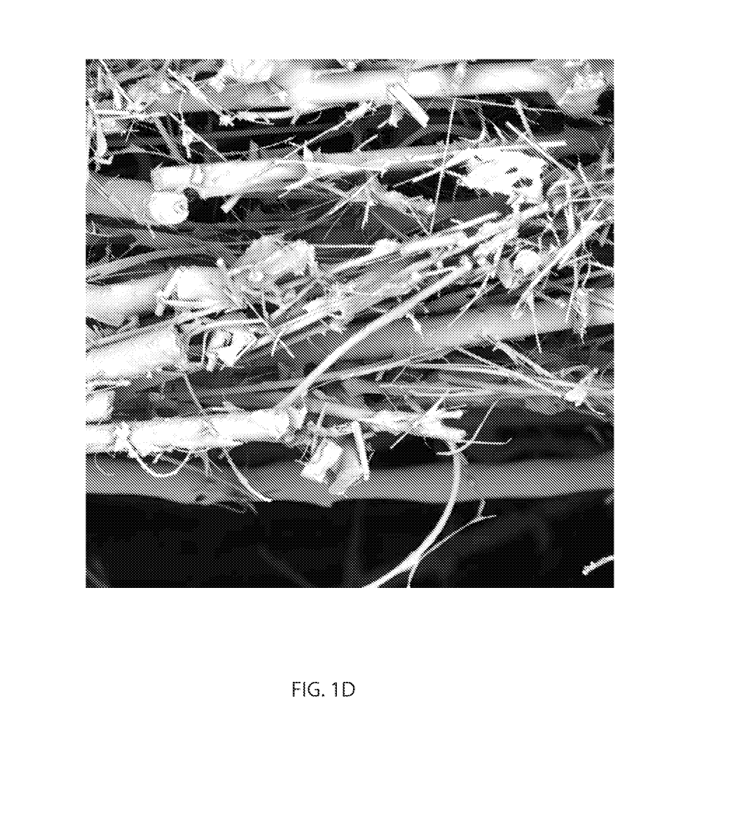

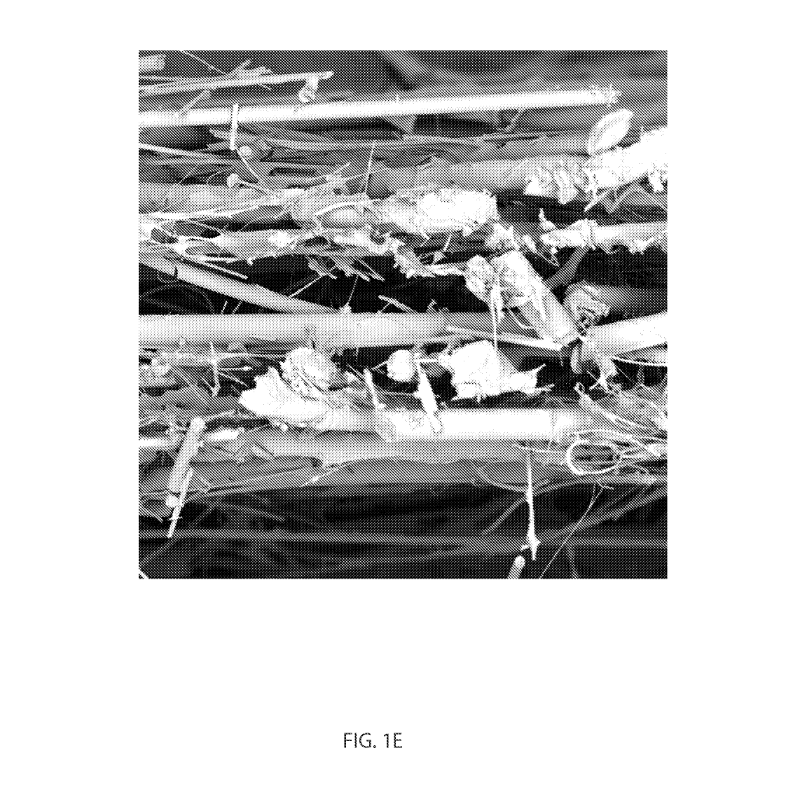

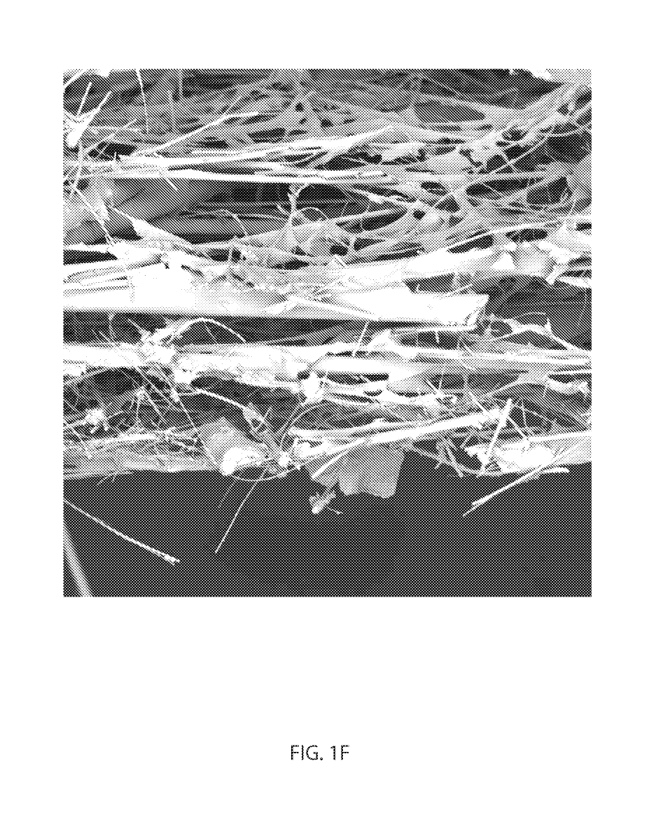

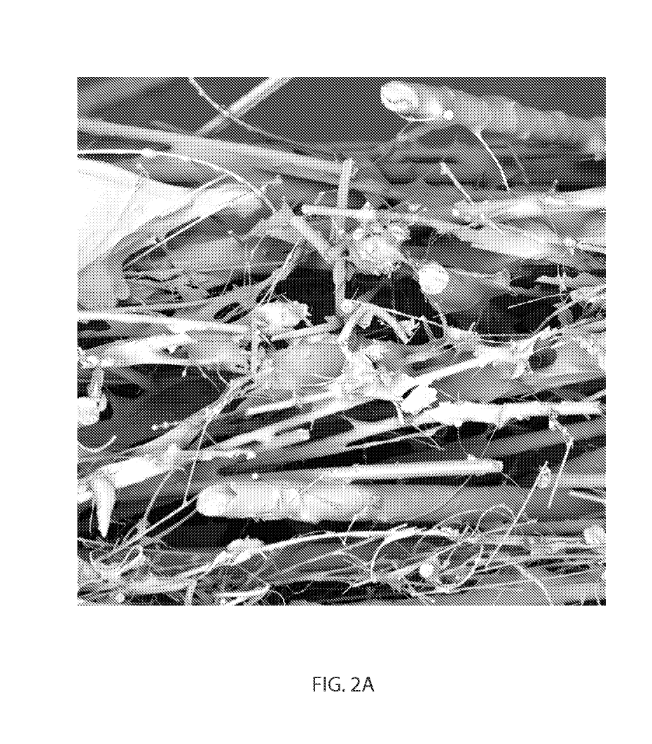

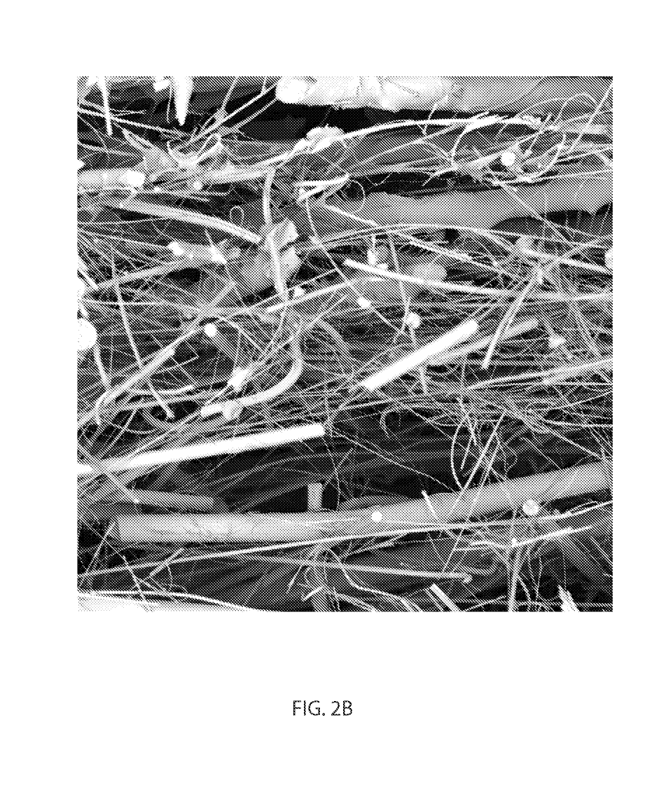

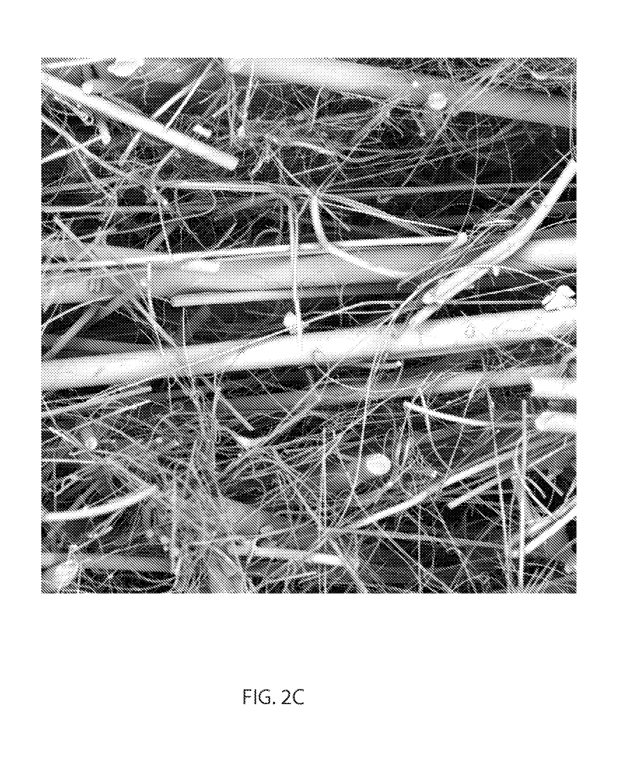

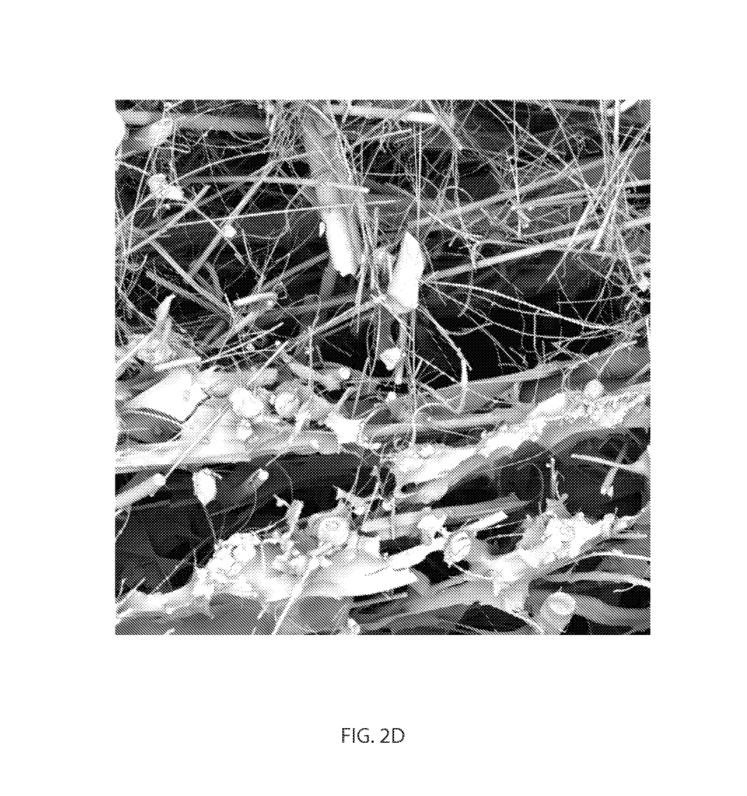

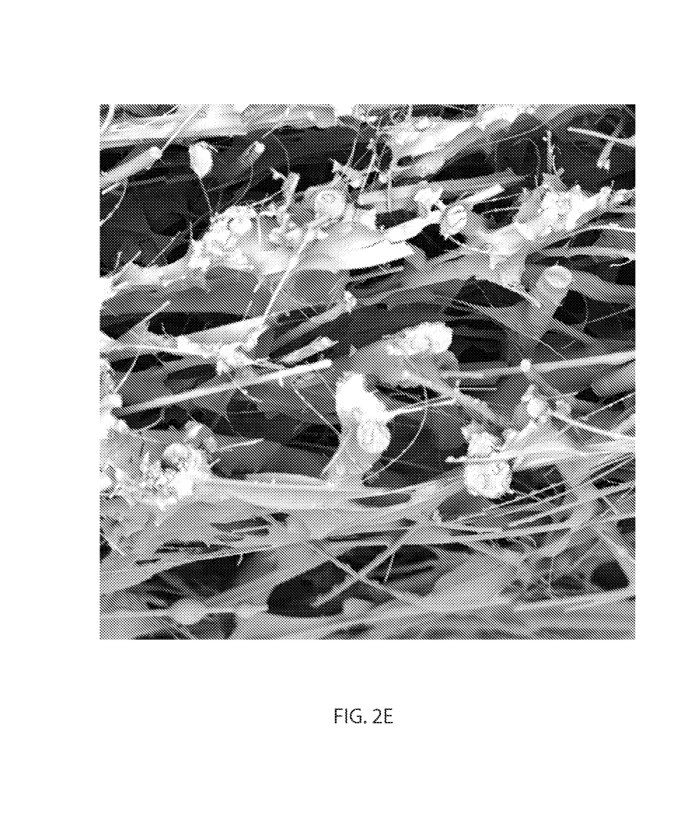

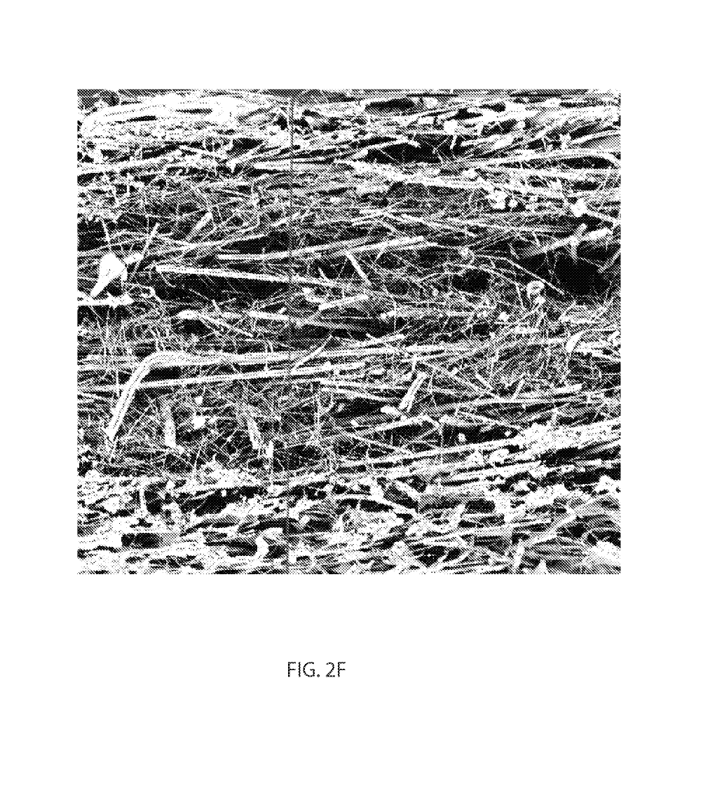

Examples 13 and 18, both having about 14 wt % resin pickup, were examined using scanning electron microscopy (SEM) by slicing open a section through the thickness of each of the two mats and imaging the exposed surface thereof. The SEM micrograph images, all taken at 1000× or 1020× are shown in FIGS. 1A-1F and 2A-2F. FIGS. 1A-1F shows the mat of Example 13 at the top edge (1A), bottom edge (1F) and four areas between the edges and proceeding from the top toward the bottom edge (1B, 1C, 1D, 1E). FIGS. 2A-2E shows the mat of Example 18 at the top edge (2A), bottom edge (2E) and three areas between the edges and proceeding from the top toward the bottom edge (2B, 2C, 2D). FIG. 2F shows an image composite of the entire thickness of the Example 18 mat, wherein the arrow indicates the total thickness of the imaged area. The arrow represents a distance of 1.02 mm.

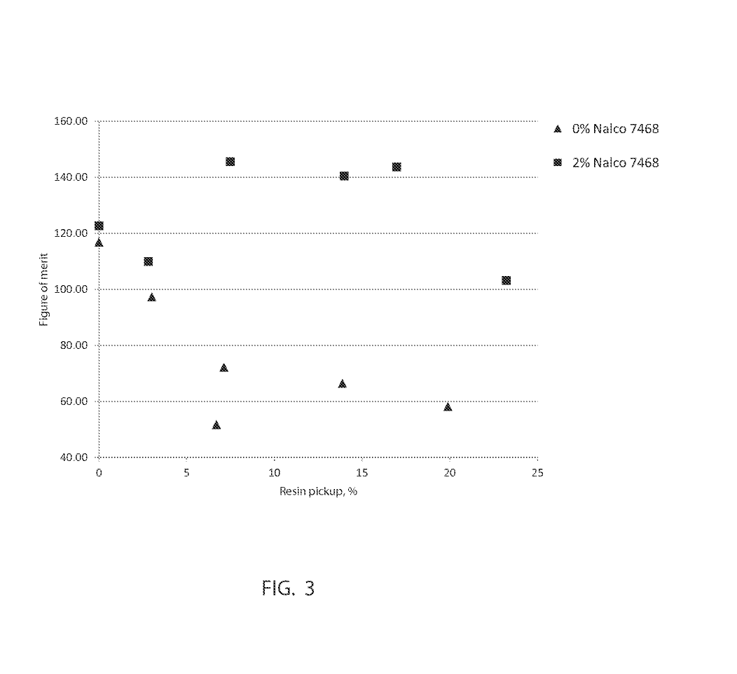

Figure of merit (Fμ) was calculated for each of Examples 9-20. The Fμ for the handsheets of Examples 9-20 is shown in Table 5 and in FIG. 3, where Fμ is plotted as a function of % resin pickup. The object of Fμ is to compare performance between different filter media. Fμ is calculated as

Fμ−Log(Penetrationₙ)*permeability*f

### Where

Penetrationₙ is normalized penetration for 0.18 μm count median diameter (CMD) particles, at a velocity of 5.33 cm/s
Permeability, ft³ air/ft² media/min, measured at pressure drop of 0.5 inches water
f is a conversion factor of 5.44

TABLE 5
Figure of merit, Fμ, for the fibrous media mats of Examples 9-20.

| Example | Fμ |
|---|---|
| 9 | 116.88 |
| 10 | 97.29 |
| 11 | 51.73 |
| 12 | 72.19 |
| 13 | 66.39 |
| 14 | 58.15 |
| 15 | 122.70 |
| 16 | 109.96 |
| 17 | 145.60 |
| 18 | 140.43 |
| 19 | 143.69 |
| 20 | 103.21 |

### Examples 21-35

A fiber slurry was formed as follows. A lab mixer equipped with a pitched blade propeller was charged with 2.7 liters of water, and sulfuric acid was added to adjust the pH of the water to about 3. Then K-137 fibers were added and the contents of the mixer were stirred for 1000 revolutions of the propeller. Then B-08 fibers and B-50 fibers were added, and the contents of the mixer were stirred for another 8000 revolutions of the propeller. Then 271P fibers were added, and the contents of the mixer were stirred for another 1000 revolutions of the propeller. In this manner, a mixture having dry weight percentages corresponding to 75% K-137, 5% B-08, 5% B-50, and 15% 271P was formed. In some Examples, Nalco 7468 was added to the mixer in amount corresponding to 1 wt % Nalco 7468 as received, based on the total dry weight of the fibers, and the contents of the mixer were stirred for another 200 revolutions of the propeller. The blending was repeated for each of Examples 21-35 to result in the fiber slurries.

Each fiber slurry was poured into a 30.5 cm×30.5 cm handsheet mold used to make paper handsheets, and handsheet mats were formed using standard papermaking techniques. The mats were dried using an Emerson Apparatus Model 135 heated press (obtained from Emerson Apparatus, Inc. of Gorham, Me.) set at a temperature of 127° C. by placing 0.16 cm wire spacers on the bottom platen, placing the mat on the bottom (heated) platen, closing the apparatus, allowing the temperature of the bottom platen to return to 127° C., leaving the apparatus closed for an additional 60 seconds; opening the apparatus, flipping the mat over, closing the apparatus, allowing the temperature of the bottom platen to return to 127° C., then leaving the mat in the apparatus for an additional 60 seconds before removing the mat from the apparatus.

PM490 was diluted to a selected concentration with deionized water. For each of the mats of Example 21-35, the amount of PM490 resin in the water was carefully adjusted to result in the observed weight percent of resin pickup, further to provide similar resin weight pickups for comparison of mats having no Nalco 7468 and the mats having Nalco 7468, as shown in Table 6. The diluted resin mixture was placed in a pan and 12.7 cm×12.7 cm sections of the mats, cut from the handsheet samples, were immersed in the liquid in the pan for about 6 seconds. The mats were drained by holding vertically until the PM-490 dispersion nearly stopped dripping from the mat, then dried by placing them in a convection oven set to 149° C. for between 7 and 9 minutes.

Initial basis weight (before addition of PM-490) final basis weight (after addition of PM-490), weight percent of resin added to the mats, permeability, resistance, and penetration, and efficiency were measured for the mats with and without Nalco 7468, as shown in Table 6.

TABLE 6
Properties measured for the mats formed with no Nalco 7468 and with Nalco 7468
added to the slurry at 2 wt % as received, based on the total dry fiber weight.

| | | | | | | | |
|---|---|---|---|---|---|---|---|
| | Initial | Final | | | | | |
| | Basis | Basis | Resin | | | | |
| Ex. | wt, | wt, | pick | Permeability, | % | % | Resistance, |
| No. | g/m² | g/m² | up, wt % | m³/m²min | Penetration | Efficiency | in. H₂O |

0% Nalco 7468

| | | | | | | | |
|---|---|---|---|---|---|---|---|
| 21 | 161.20 | 161.20 | 0 | 49.38 | 71.66 | 28.34 | 0.02 |
| 22 | 165.55 | 176.70 | 6.74 | 49.99 | 79.36 | 20.64 | 0.022 |
| 23 | 166.17 | 180.42 | 8.58 | 49.68 | 79.13 | 20.87 | 0.018 |
| 24 | 159.96 | 168.02 | 5.04 | 51.82 | 79.89 | 20.11 | 0.031 |
| 25 | 158.73 | 179.19 | 12.89 | 51.82 | 81.14 | 18.86 | 0.021 |

1 wt % Nalco 7468

| | | | | | | | |
|---|---|---|---|---|---|---|---|
| 26 | 155.62 | 155.62 | 0 | 48.46 | 73.44 | 26.56 | 0.024 |
| 27 | 162.44 | 170.49 | 4.96 | 48.46 | 70.64 | 29.36 | 0.024 |
| 28 | 168.02 | 177.31 | 5.54 | 46.02 | 71.42 | 28.58 | 0.021 |
| 29 | 166.17 | 176.08 | 5.97 | 48.77 | 72.84 | 27.16 | 0.027 |
| 30 | 163.06 | 175.46 | 7.60 | 45.72 | 73.28 | 26.72 | 0.022 |
| 31 | 164.93 | 179.80 | 9.02 | 46.33 | 73.82 | 26.18 | 0.027 |
| 32 | 164.29 | 186.00 | 13.21 | 48.46 | 75.59 | 24.41 | 0.024 |
| 33 | 168.64 | 182.28 | 8.09 | 46.94 | 74.36 | 25.64 | 0.026 |
| 34 | 160.58 | 172.37 | 7.34 | 47.55 | 75.59 | 24.41 | 0.027 |
| 35 | 164.29 | 176.70 | 7.55 | 48.16 | 73.74 | 26.26 | 0.025 |

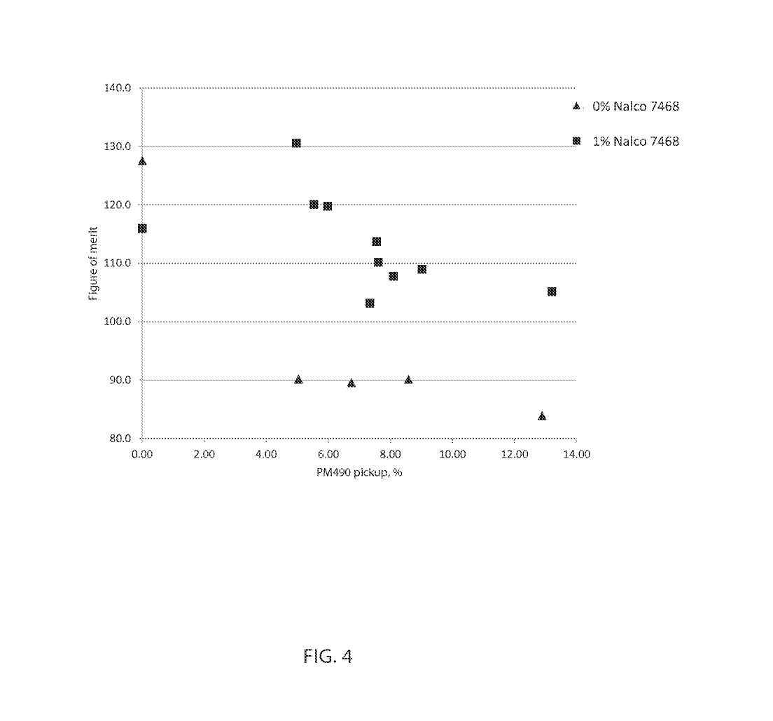

Figure of merit (Fμ) was calculated for each of Examples 21-35 in the same manner described for Examples 9-20, and the results of the calculation are shown in Table 7 and in FIG. 4, where Fμ is plotted as a function of % PM-490 pickup.

TABLE 7
Figure of merit, Fμ, for the handsheets of Examples 21-35.

| Example | Fμ |
|---|---|
| 21 | 127.5 |
| 22 | 89.6 |
| 23 | 90.1 |
| 24 | 90.2 |
| 25 | 83.9 |
| 26 | 116.0 |
| 27 | 130.6 |
| 28 | 120.1 |
| 29 | 119.8 |
| 30 | 110.2 |
| 31 | 109.0 |
| 32 | 105.1 |
| 33 | 107.8 |
| 34 | 103.1 |
| 35 | 113.7 |

### Examples 36-39

A fiber slurry was formed as follows. A lab mixer equipped with a pitched blade propeller was charged with 2.7 liters of water, and sulfuric acid was added to adjust the pH of the water to about 3. Then B-08 fibers and B-50 fibers were added, and the contents of the mixer were stirred for 9000 revolutions of the propeller. Then 271P fibers were added, and the contents of the mixer were stirred for another 1000 revolutions of the propeller. In this manner, a mixture having dry weight percentages corresponding to 8% B-08, 47% B-50, and 45% 271P was formed. In some Examples, Nalco 7468 was added to the mixer in amount corresponding to 3 wt % of the Nalco 7468 as received, based on the total dry weight of the fibers, and the contents of the mixer were stirred for another 200 revolutions of the propeller. The blending was repeated for each of Examples 36-39 to result in the fiber slurries.

Each fiber slurry was poured into a 30.5 cm×30.5 cm handsheet mold used to make paper handsheets, and handsheet mats were formed using standard papermaking techniques. The mats were dried using an Emerson Apparatus Model 135 heated press (obtained from Emerson Apparatus, Inc. of Gorham, Me.) set at a temperature of 127° C. by placing the mat on the bottom (heated) platen, closing the apparatus, allowing the temperature of the bottom platen to return to 127° C., leaving the apparatus closed for an additional 60 seconds; opening the apparatus, flipping the mat over, closing the apparatus, allowing the temperature of the bottom platen to return to 127° C., then leaving the mat in the apparatus for an additional 60 seconds before removing the mat from the apparatus.

Hycar 26921 was diluted to a selected concentration with deionized water. For each Example 36-39, the amount of Hycar 26921 added to the water was carefully adjusted to result in the observed weight percent of resin pickup, further to provide similar resin weight pickups for comparison of mats having no Nalco 7468 and the mats having Nalco 7468, as shown in Table 8. The diluted resin mixture was placed in a pan and 12.7 cm×12.7 cm sections of the mats, cut from the handsheet samples, were immersed in the liquid in the pan for about 6 seconds. The mats were drained by holding vertically until the Hycar 26921 dispersion nearly stopped dripping from the mat, then the mats were placed in a convection oven set to 104° C. until dry. Then the dried mats were placed in a convection oven set to 135° C. for about 2 minutes.

Initial basis weight (before addition of Hycar 26921) final basis weight (after addition of Hycar 26921), weight percent of resin added to the mats, permeability, penetration, efficiency, and resistance, were measured for the mats having no Nalco 7468 and mats having Nalco 7468 added, as shown in Table 8.

TABLE 8
Properties measured for the mats formed with no Nalco 7468 and with Nalco 7468
added to the slurry at 3 wt % as received, based on the total dry fiber weight.

| | | | | | | | |
|---|---|---|---|---|---|---|---|
| | Initial | Final | Resin | | | | |
| | Basis | Basis | pick | | | | |
| Ex. | wt, | wt, | up, | Permeability, | % | % | Resistance, |
| No. | g/m² | g/m² | wt % | m³/m²/min | Penetration | Efficiency | in. H₂O |

0% Nalco 7468

| | | | | | | | |
|---|---|---|---|---|---|---|---|
| 36 | 117.83 | 120.92 | 2.63 | 9.81 | 34.36 | 65.6 | 0.168 |
| 37 | 114.09 | 120.27 | 5.43 | 9.78 | 36.69 | 63.3 | 0.163 |

3 wt % Nalco 7468

| | | | | | | | |
|---|---|---|---|---|---|---|---|
| 38 | 116.53 | 119.62 | 2.66 | 10.30 | 28.80 | 71.2 | 0.155 |
| 39 | 114.09 | 120.27 | 5.43 | 9.78 | 31.68 | 68.3 | 0.166 |

Figure of merit (Fμ) was calculated for each of Examples 36-39 in the same manner described for Examples 9-20, and the results of the calculation are shown in Table 9.

TABLE 9
Figure of merit, Fμ, for the handsheets of Examples 36-39.

| Example | Fμ |
|---|---|
| 36 | 81.3 |
| 37 | 76.0 |
| 38 | 99.4 |
| 39 | 87.2 |

The present invention may suitably comprise, consist of, or consist essentially of, any of the disclosed or recited elements. As used herein, the term “consisting essentially of” does not exclude the presence of additional equipment or materials which do not significantly affect the desired characteristics, properties, or use of a given composition, product, method, or apparatus.

The invention illustratively disclosed herein can be suitably practiced in the absence of any element which is not specifically disclosed herein. The various embodiments described above are provided by way of illustration only and should not be construed to limit the claims attached hereto. It will be recognized that various modifications and changes may be made without following the example embodiments and applications illustrated and described herein, and without departing from the true spirit and scope of the following claims.

We claim:

1. A nonwoven fibrous media having a first major surface and a second major surface defining the media thickness, the media comprising one or more peripheral regions, one or more bulk regions, and a binder resin; wherein each of the one or more peripheral regions comprises a major surface and about 1% to 25% of the media thickness adjacent to the major surface, and wherein the one or more peripheral regions together comprise about 80 wt % to 100 wt % of the total weight of the binder resin.

2. The media of any of claims 1 and 3-6, wherein the media comprises a total of 0.5% to 20% by weight of binder resin based on the total weight of the media.

3. The media of any of claims 1-2 and 4-6, wherein the Figure of Merit for the media is at least 80% of the Figure of Merit for the media without binder.

4. The media of any of claims 1-3 and 5-6, wherein the media comprises a first peripheral region comprising the first major surface, and a second peripheral region comprising the second major surface.

5. The media of any of claims 1-4 and 6, wherein the fibrous media comprises fibers comprising one or more polyester fibers, polyamide fibers, polyolefin fibers, glass fibers, or bicomponent fibers.

6. The media of any of claims 1-5, wherein the binder resin comprises an acrylic polymer, a polyurethane, a fluoropolymer, a phenolic resin, a silicone polymer, or an epoxy functional polymer.

7. A filter element comprising one or more layers of filtration media, the filtration media comprising the nonwoven fibrous media of claim 1.

8. The filter element of any of claims 7 and 9-10, wherein the filter element further comprises a scrim, a wire support, or a frame.

9. The filter element of any of claims 7-8 and 10, wherein the scrim, a wire support, or frame is bound to the filtration media by the binder resin.

10. The filter element of any of claims 7-9, wherein the filter element comprises two or more layers of the media of claim 1, wherein the layers are stacked or wound layers.

11. A nonwoven fibrous media made by the method comprising the steps of
a. adding a hydrophobic agent to fibers,
b. forming a nonwoven fibrous media from the fibers,
c. adding a binder resin to the fibrous media, wherein the binder resin is added to the media in the form of a dispersion, a solution, or an emulsion; and
d. drying the fibrous media.

12. The media of any of claims 11 and 13-18, wherein the steps are carried out in the order a, b, c, d.

13. The media of any of claims 11-12 and 14-18, wherein the steps are carried out in the order b, a, c, d.

14. The media of any of claims 11-13 and 15-18, wherein the binder further comprises one or more additional binder materials, the one or more additional binder materials comprising one or more particulates, functional polymers, or crosslinkers.

15. The media of any of claims 11-14 and 16-18, wherein, after the drying, the media comprises one or more peripheral regions and one or more bulk regions, wherein each of the one or more peripheral regions comprises a major surface and about 1% to 25% of the media thickness adjacent to the major surface, and wherein the one or more peripheral regions together comprise about 80 wt % to 100 wt % of the total weight of the binder.

16. The media of any of claims 11-15 and 17-18, wherein the hydrophobic agent is added to the fibers during formation of the fibers.

17. The media of any of claims 11-16 and 18, wherein the hydrophobic agent comprises a dialkylsiloxane oligomer, a dialkylsiloxane polymer, or a combination of two or more thereof.

18. The media of any of claims 11-17, wherein the hydrophobic agent comprises polydimethylsiloxane.

19. A filter element comprising the nonwoven fibrous media of claim 11, wherein the method further comprises layering two or more layers of the media together, adding a scrim or a wire support to the media, disposing the media within a frame, or a combination thereof.

20. The filter element of claim 19, wherein the adding a scrim or wire support, or disposing the media within a frame, or both, is carried out after step c. but before step d.

21. A method of making a nonwoven fibrous media, the method comprising
a. adding a hydrophobic agent to fibers,
b. forming a nonwoven fibrous media from the fibers,
c. adding a binder resin to the fibrous media, wherein the binder resin is added to the media in the form of a dispersion, a solution, or an emulsion; and
d. drying the fibrous media.

22. The method of any of claims 21 and 23-24, wherein the method is carried out in the order a, b, c, d.

23. The method of any of claims 21-22 and 24, wherein the method is carried out in the order b, a, c, d.

24. The method of any of claims 21-23, wherein the hydrophobic agent is added to the fibers during formation of the fibers.
